(19) United States
(12) Patent Application Publication
(10) Pub. No.: US 2023/0100955 A1
(43) Pub. Date: Mar. 30, 2023

(54) METHODS AND APPARATUS FOR SUPPLYING CONFIGURATION DATA TO CONTROLLERS OF GRILLS

(71) Applicant: Weber-Stephen Products LLC, Palatine, IL (US)

(72) Inventors: Victor Mercado, JR., Berwyn, IL (US); José Ángel Martinez, Franklin Park, IL (US); Angela Maria Schilt, Mundelein, IL (US)

(21) Appl. No.: 17/857,876

(22) Filed: Jul. 5, 2022

Related U.S. Application Data
(60) Provisional application No. 63/250,004, filed on Sep. 29, 2021.

(51) Int. Cl. A47J 36/32; A47J 37/07

(52) U.S. Cl. CPC A47J 36/321; A47J 37/0713; A47J 37/0786

(57) ABSTRACT

Example methods and apparatus for supplying configuration data to controllers of grills are disclosed. An example grill includes a controller and a dongle. The dongle is connectable to the controller. The dongle includes memory storing configuration data associated with the grill. The controller is to read the configuration data from the memory in response to the dongle being connected to the controller.

### RELATED APPLICATIONS

This application claims priority to U.S. Provisional Patent Application No. 63/250,004, filed Sep. 29, 2021. The entirety of U.S. Provisional Patent Application No. 63/250,004 is hereby incorporated by reference herein.

### FIELD OF THE DISCLOSURE

This disclosure relates generally to controllers for grills and, more specifically, to methods and apparatus for supplying configuration data to controllers of grills.

### BACKGROUND

Some known grills are equipped with a controller and a connected user interface that are collectively configured to implement and/or guide various controlled cooking operations and/or steps in association with one or more selectable cook program(s). In conventional implementations, the controller and the user interface of a particular grill are without knowledge of configuration data that is specific (e.g., unique) to the grill. For example, the controller and the user interface of a particular grill may be devoid of information detailing the presence (or the absence), the location, the orientation, the layout, the arrangement, the number, the size, the type, and/or the functional capability of various components (e.g., burners, valves, ignitors, cooking surfaces, tables, lighting modules, temperature sensors, flame sensors, lid position sensors, fuel level sensors, etc.) of the grill. As another example, the controller and the user interface of a particular grill may be devoid of product manufacturing information (e.g., a manufacturer, a manufacturing date, a manufacturing location, etc.) and/or product identification information (e.g., a make, a model, a unique identifier (e.g., a product serial number), etc.) associated with the grill.

In some examples, the above-described lack of awareness on the part of the controller and the user interface results in certain processes associated with the grill being cumbersome in terms of the amount of user (e.g., human) interaction that may be required. For example, because the controller and the user interface are devoid of product manufacturing information and/or product identification information, the process of registering the grill typically requires a user to physically locate such information in printed form, either on the grill itself or on product literature provided with the grill at the time of sale and/or purchase. Once such product manufacturing information and/or product identification information has been physically located by the user, the user will then typically be required to input such information into an electronic submission form via a remote device (e.g., a smartphone, a personal computer, etc.) to complete the registration process.

In other examples, the above-described lack of awareness on the part of the controller and the user interface results in certain processes associated with the grill being less than optimal. For example, because the controller and the user interface are devoid of information detailing the presence (or the absence), the location, the orientation, the layout, the arrangement, the number, the size, the type, and/or the functional capability of various components of the grill, cook programs that are available for selection and implementation by the controller and the user interface are typically generalized to account for use across a broad range of grill makes, models, and/or types, as opposed to the cook programs being optimized according to the specific configuration data associated with any particular grill.

### BRIEF DESCRIPTION OF THE DRAWINGS

FIG. 1 is a block diagram of an example grill constructed in accordance with the teachings of this disclosure.

FIG. 2 a block diagram of the memory of the dongle of FIG. 1.

FIG. 3 is a perspective view of an example implementation of the grill of FIG. 1.

FIG. 4 is a perspective view of the implementation of the grill shown in FIG. 3, with the lid of the grill, the side burner cover of the second side table, and the doors of the cabinet removed.

FIG. 5 is a top view of the implementation of the grill shown in FIGS. 3 and 4, with the lid of the grill, the side burner cover of the second side table, the doors of the cabinet, and the grilling grates of the cookbox removed.

FIG. 6 is a top view of the implementation of the grill shown in FIGS. 3-5, with the lid of the grill, the side burner cover of the second side table, the doors of the cabinet, the grilling grates of the cookbox, and the control panel of the grill removed.

FIG. 7 is perspective view of an example implementation of the dongle of FIGS. 1 and 2.

FIG. 8 is a bottom-side perspective view of the first side table of the implementation of the grill of FIG. 1 as shown in FIGS. 3-6.

FIG. 9 is an enlarged view of a portion of FIG. 8.

FIG. 10 is a bottom-side perspective view of the first side table of the implementation of the grill of FIG. 1 as shown in FIGS. 3-6, 8, and 9, with the implementation of the dongle of FIGS. 1 and 2 as shown in FIG. 7 mounted to the first side table, and with the dongle disconnected from the controller.

FIG. 11 is an enlarged view of a portion of FIG. 10.

FIG. 12 is a bottom-side perspective view of the first side table of the implementation of the grill of FIG. 1 as shown in FIGS. 3-6 and 8-11, with the implementation of the dongle of FIGS. 1 and 2 as shown in FIGS. 7, 10, and 11 mounted to the first side table, and with the dongle connected to the controller.

FIG. 13 is an enlarged view of a portion of FIG. 12.

FIG. 14 is a flowchart representative of example machine-readable instructions and/or example operations that may be executed by processor circuitry to implement the grill of FIG. 1.

FIG. 15 is a another flowchart representative of example machine-readable instructions and/or example operations that may be executed by processor circuitry to implement the grill of FIG. 1.

FIG. 16 is a block diagram of an example processor platform including processor circuitry structured to execute and/or instantiate the machine-readable instructions and/or operations of FIGS. 14 and 15 to implement the grill of FIG. 1.

FIG. 17 is a block diagram of an example implementation of the processor circuitry of FIG. 16.

FIG. 18 is a block diagram of another example implementation of the processor circuitry of FIG. 17.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Some known grills are equipped with a controller and a connected user interface that are collectively configured to implement and/or guide various controlled cooking operations and/or steps in association with one or more selectable cook program(s). In conventional implementations, the controller and the user interface of a particular grill are without knowledge of configuration data that is specific (e.g., unique) to the grill. For example, the controller and the user interface of a particular grill may be devoid of information detailing the presence (or the absence), the location, the orientation, the layout, the arrangement, the number, the size, the type, and/or the functional capability of various components (e.g., burners, valves, ignitors, cooking surfaces, tables, lighting modules, temperature sensors, flame sensors, lid position sensors, fuel level sensors, etc.) of the grill. As another example, the controller and the user interface of a particular grill may be devoid of product manufacturing information (e.g., a manufacturer, a manufacturing date, a manufacturing location, etc.) and/or product identification information (e.g., a make, a model, a unique identifier (e.g., a product serial number), etc.,) associated with the grill.

In some examples, the above-described lack of awareness on the part of the controller and the user interface results in certain processes associated with the grill being cumbersome in terms of the amount of user (e.g., human) interaction that may be required. For example, because the controller and the user interface are devoid of product manufacturing information and/or product identification information, the process of registering the grill typically requires a user to physically locate such information in printed form, either on the grill itself or one product literature provided with the grill at the time of sale and/or purchase. Once such product manufacturing information and/or product identification information has been physically located by the user, the user will then typically be required to input such information into an electronic submission form via a remote device (e.g., a smartphone, a personal computer, etc.).

In other examples, the above-described lack of awareness on the part of the controller and the user interface results in certain processes associated with the grill being less than optimal. For example, because the controller and the user interface are devoid of information detailing the presence (or the absence), the location, the orientation, the layout, the arrangement, the number, the size, the type, and/or the functional capability of various components of the grill, cook programs that are available for selection and implementation by the controller and the user interface are typically generalized to account for use across a broad range of grill makes, models, and/or types, as opposed to the cook programs being optimized according to the specific configuration data associated with any particular grill.

Unlike the known grill implementations described above, the methods and apparatus disclosed herein advantageously supply configuration data to controllers of grills. In some examples, grills disclosed herein include a controller and a dongle that is connectable to the controller. The dongle includes memory storing (e.g., preloaded with) configuration data associated with the grill. The controller is configured to read the configuration data from the memory of the dongle in response to the dongle being connected to the controller. In some examples, the controller may detect the connection between the dongle and the controller during a boot up cycle of the controller and/or, more generally, of the grill. The data read by the controller from the memory of the dongle can thereafter be stored in and/or on a main memory of the grill, and/or accessed via a user interface of the grill.

In some examples, the grill transmits the configuration data read from the memory of the dongle to one or more remote device(s) to advantageously facilitate a registration process associated with the grill. In such examples, the configuration data may include product manufacturing data and/or product identification data that may be required to complete the registration process. In such examples, the transmission of the configuration data from the grill to the remote device(s) advantageously reduces (e.g., eliminates) one or more act(s) of user involvement that is/are required in association with known grill registration processes, thereby providing a user experience that is improved relative to that provided by such known grill registration processes.

In some examples, the grill transmits the configuration data read from the memory of the dongle to one or more remote device(s) to advantageously facilitate the identification of one or more configuration-specific cook program(s). In such examples, the configuration data may include burner configuration data, valve configuration data, fuel source configuration data, ignitor configuration data, cooking surface configuration data, table configuration data, lighting module configuration data, temperature sensor configuration data, flame sensor configuration data, lid position sensor configuration data, fuel level sensor configuration data, and/or other types or categories of configuration data associated with the grill. In response to transmitting the configuration data from the grill to the remote device(s), the grill may thereafter receive configuration-specific cook program data from the remote device(s), with the configuration-specific cook program data being based on the configuration data. The controller and/or the user interface of the grill can thereafter implement one or more configuration-specific cook program(s) that is/are based on the received configuration-specific cook program data. In such examples, the implementation of the configuration-specific cook program(s) advantageously optimizes the use of cook programs at the grill, thereby providing a user experience that is improved relative to that provided by known cook program implementations.

The above-identified features as well as other advantageous features of example methods and apparatus for supplying configuration data to controllers of grills as disclosed herein are further described below in connection with the figures of the application. As used herein in a mechanical context, the term “configured” means sized, shaped, arranged, structured, oriented, positioned, and/or located. For example, in the context of a first object configured to fit within a second object, the first object is sized, shaped, arranged, structured, oriented, positioned, and/or located to fit within the second object. As used herein in an electrical and/or computing context, the term “configured” means arranged, structured, and/or programmed. For example, in the context of a controller configured to perform a specified operation, the controller is arranged, structured, and/or programmed (e.g., based on machine-readable instructions) to perform the specified operation. As used herein, the phrase “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, the term “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

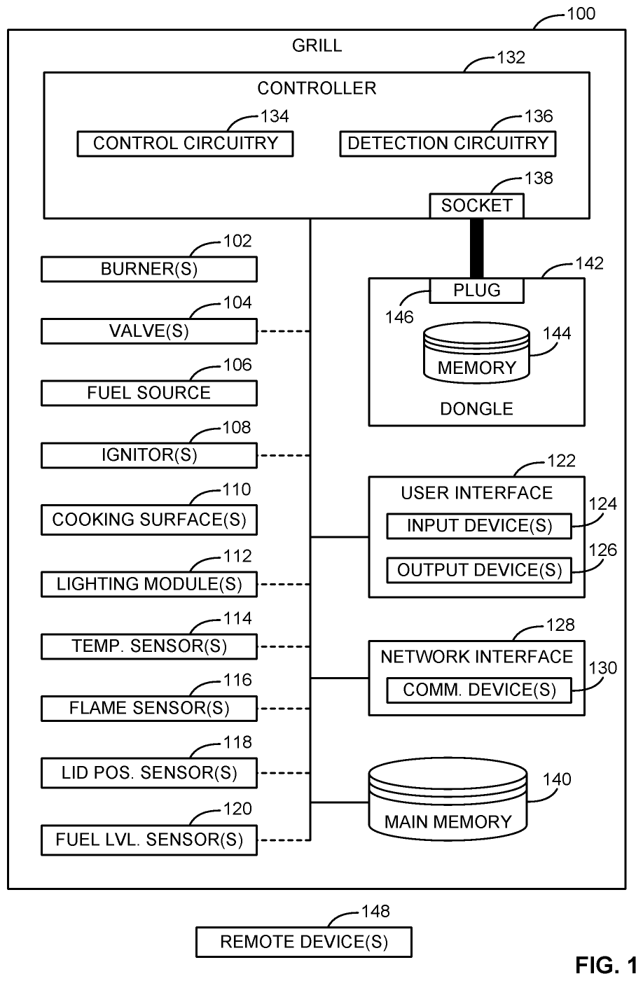

FIG. 1 is a block diagram of an example grill 100 constructed in accordance with the teachings of this disclosure. The grill 100 of FIG. 1 is a gas grill including one or more burner(s), a controller, and a user interface operatively coupled to (e.g., in wired or wireless electrical communication with) the controller. In other examples, the grill 100 can be implemented as a different type of grill (e.g., a pellet grill, an electric grill, a charcoal grill, etc.) having a heat source, a controller, and a user interface operatively coupled to (e.g., in wired or wireless electrical communication with) the controller.

In the illustrated example of FIG. 1, the grill 100 includes one or more example burner(s) 102, one or more example valve(s) 104, an example fuel source 106, one or more example ignitor(s) 108, one or more example cooking surface(s) 110, one or more example lighting module(s) 112, one or more example temperature sensor(s) 114, one or more example flame sensor(s) 116, one or more example lid position sensor(s) 118, one or more example fuel level sensor(s) 120, an example user interface 122 (e.g., including one or more example input device(s) 124 and one or more example output device(s) 126), an example network interface 128 (e.g., including one or more example communication device(s) 130), an example controller 132 (e.g., including example control circuitry 134, example detection circuitry 136, and an example socket 138), an example main memory 140, and an example dongle 142 (e.g., including an example memory 144 and an example plug 146). The grill 100 of FIG. 1 is configured to communicate (e.g., wirelessly communicate) with one or more example remote device(s) 148, as further described below. In other examples, one or more of the above-described components of the grill 100 may be omitted. In still other examples, the grill 100 may include one or more other component(s) in addition or as an alternative to the above-described components of the grill 100.

The grill 100 of FIG. 1 includes a control system for instructing, guiding, and/or implementing one or more selectable cook program(s) that respectively include various ordered steps, instructions, and/or operations by which one or more item(s) of food is/are to be cooked within a cooking chamber and/or on a cooking surface of the grill 100. In the illustrated example of FIG. 1, the control system of the grill 100 includes the user interface 122 (e.g., including the input device(s) 124 and the output device(s) 126), the network interface 128 (e.g., including the communication device(s) 130), the controller 132 (e.g., including the control circuitry 134 and the detection circuitry 136), the main memory 140, and the dongle 142 (e.g., including the memory 144) of the grill 100. In other examples, the control system of the grill 100 further includes one or more of the valve(s) 104, one or more of the ignitor(s) 108, one or more of the lighting module(s) 112, one or more of the temperature sensor(s) 114, one or more of the flame sensor(s) 116, one or more of the lid position sensor(s) 118, and/or one or more of the fuel level sensor(s) 120 of the grill 100. In still other examples, the control system of the grill 100 can further include one or more of the remote device(s) 148 that are configured to communicate (e.g., wirelessly communicate) with the grill 100.

The control system of the grill 100 of FIG. 1 is powered and/or operated by a power source. For example, the electrical components that form the control system of the grill 100 can be powered and/or operated by DC power supplied via one or more on-board or connected batteries of the grill 100. As another example, the electrical components that form the control system of the grill 100 can alternatively be powered and/or operated by AC power supplied via household electricity or wall power to which the grill 100 is connected. The grill 100 includes a power button (e.g., a power switch) that is configured to enable (e.g., power on) or disable (e.g., power off) the control system of the grill 100 in response to the power button being manually actuated by a user of the grill 100.

The grill 100 of FIG. 1 further includes a cookbox configured to support, carry, and/or house one or more structures of the grill 100 including, for example, one or more of the burner(s) 102, one or more of the valve(s) 104, one or more of the ignitor(s) 108, one or more of the cooking surface(s) 110, one or more of the lighting module(s) 112, one or more of the temperature sensor(s) 114, one or more of the flame sensor(s) 116, and/or one or more of the lid position sensor(s) 118 of the grill 100. The cookbox of the grill 100 may be of any size, shape, and/or configuration.

The grill 100 of FIG. 1 further includes a lid configured to cover and/or enclose the cookbox of the grill 100 when the lid is in a closed position. In some examples, the lid is movably (e.g., pivotally) coupled to the cookbox such that the lid can be moved (e.g., pivoted) relative to the cookbox between a closed position and an open position. In other examples, the lid can instead be removably positioned on the cookbox without there being any direct mechanical coupling between the lid and the cookbox. In some such other examples, the lid can be movably (e.g., pivotally) coupled to one or more structure(s) of the grill 100 other than the cookbox. For example, the lid can be movably (e.g., pivotally) coupled to a frame, to a cabinet, and/or to one or more side table(s) of the grill 100. Movement of the lid between the closed position and the open position can be facilitated via user interaction with a handle that is coupled to the lid.

The cookbox and the lid of the grill 100 collectively define a cooking chamber configured to cook one or more item(s) of food. The cooking chamber of the grill 100 becomes accessible to a user of the grill 100 when the lid of the grill 100 is in the open position. Conversely, the cooking chamber of the grill 100 is generally inaccessible to the user of the grill 100 when the lid of the grill 100 is in the closed position. User access to the cooking chamber of the grill 100 may periodically become necessary, for example, to add an item of food to the cooking chamber (e.g., at or toward the beginning of a cook program), to remove an item of food from the cooking chamber (e.g., at or toward the end of a cook program), and/or to flip, rotate, relocate, or otherwise move an item of food within the cooking chamber (e.g., during the middle of a cook program).

In some examples, the grill 100 of FIG. 1 further includes a frame configured to support the cookbox of the grill 100. In some such examples, the frame of the grill 100 forms a cabinet within which one or more component(s) of the grill 100 can be housed and/or stored. In other examples, the cabinet of the grill 100 can be omitted in favor of an open-space configuration of the frame. In some examples, the grill 100 of FIG. 1 further includes a control panel located along the front portion of the cookbox. In some such examples, one or more control knob(s) (e.g., one or more burner and/or valve control knob(s)) and/or one or more control button(s) (e.g., one or more ignitor and/or lighting module control button(s)) is/are carried by, mounted to, and/or otherwise located along the control panel. In some examples, the grill 100 of FIG. 1 further includes one or more table(s) located along a side portion or a front portion of the cookbox. Various components of the grill 100 of FIG. 1 described herein can be supported by, carried by, housed by, mounted to, and/or otherwise coupled to at least one of the cookbox, the lid, the handle, the frame, the cabinet, the control panel, the control knob(s), the control button(s), and/or the table(s) of the grill 100.

The burner(s) 102 of the grill 100 of FIG. 1 can be implemented by any number(s), any type(s), and/or any configuration(s) of burner(s). The burner(s) 102 are configured to emit flames to facilitate cooking one or more item(s) of food located within a cooking chamber of the grill 100, and/or located on a side burner of the grill 100. In some example(s), one or more of the burner(s) 102 is/are implemented as a burner tube (e.g., a linear burner tube, a P-shaped burner tube, etc.) located within the cookbox of the grill 100, with the burner tube including a gas inlet for receiving a flow of combustible gas, and further including a plurality of apertures configured to emit flames generated in response to ignition of the gas flowing into and/or through the burner tube. In some examples, one or more of the burner(s) 102 is/are implemented as an infrared burner or a searing burner located within the cookbox of the grill 100. In some examples, one or more of the burner(s) 102 is/are implemented as a side burner located outside of the cookbox (e.g., mounted to one of the table(s)) of the grill 100.

The valve(s) 104 of the grill 100 of FIG. 1 can be implemented by any number(s), any type(s), and/or any configuration(s) of valve(s). The valve(s) 104 is/are configured to control a flow of combustible gas between the fuel source 106 of the grill 100 and the burner(s) 102 of the grill 100. In some examples, the valve(s) 104 of the grill 100 include a fuel source valve operatively positioned (e.g., within a gas train of the grill 100) between the fuel source 106 of the grill 100 and a manifold of the grill 100. In some such examples, the fuel source valve is configured to be movable between a closed position that prevents gas contained within the fuel source 106 of the grill 100 from flowing into the manifold of the grill 100, and an open position that enables gas contained within the fuel source 106 to flow from the fuel source 106 into the manifold of the grill 100.

In some examples, the valve(s) 104 of the grill 100 include one or more burner valve(s) operatively positioned (e.g., within a gas train of the grill 100) between the manifold of the grill 100 and corresponding ones of the burner(s) 102 of the grill 100. In some such examples, each burner valve is configured to be movable between a closed position that prevents gas contained within the manifold of the grill 100 from flowing into a corresponding one of the burner(s) 102 of the grill 100, and an open position that enables gas contained within the manifold of the grill 100 to flow from the manifold into the corresponding one of the burner(s) 102. In some such examples, a gas inlet of the burner valve is located within the manifold of the grill 100, and a gas outlet of the burner valve is located within the corresponding one of the burner(s) 102 of the grill 100.

In some examples, one or more of the valve(s) 104 of the grill 100 is/are implemented as a manually-operable valve that is configured to transition from a closed position to an open position, and vice-versa, in response to a user interacting with a control knob that is mechanically coupled to a stem of the valve. In some examples, one or more of the valve(s) 104 of the grill 100 is/are implemented as a controllable electric valve (e.g., a solenoid valve) that is configured to transition from a closed position to an open position, and vice-versa, in response to instructions, commands, and/or signals (e.g., a supply of current) generated by the controller 132 of the grill 100.

The fuel source 106 of the grill 100 of FIG. 1 can be implemented by any type and/or any configuration of fuel source. In some examples, the fuel source 106 is implemented as a fuel tank (e.g., a propane tank) containing combustible gas. In such examples, the fuel source 106 will typically be located partially or fully within a cabinet of the grill 100, partially or fully within a spatial footprint formed by a frame of the grill 100, below a cookbox of the grill 100 and partially or fully within a spatial footprint formed by the cookbox of the grill 100, or below the cookbox of the grill 100 and partially or fully within a spatial footprint formed by a side table of the grill 100. In other examples, the fuel source 106 can instead be implemented as a piped (e.g., household) natural gas line that provides an accessible flow of combustible gas. The grill 100 of FIG. 1 further includes a gas train that extends from the fuel source 106 to a manifold of the grill 100, and from the manifold of the grill 100 to respective ones of the burner(s) 102 of the grill 100. The gas train can be implemented via one or more conduit(s) (e.g., one or more rigid or flexible pipe(s), tube(s), hose(s), etc.) that are configured to carry combustible gas.

The ignitor(s) 108 of the grill 100 of FIG. 1 can be implemented by any number(s), any type(s), and/or any configuration(s) of ignitor(s). In some examples, at least one of the ignitor(s) 108 is mechanically coupled and/or operatively positioned relative to a corresponding one of the burner(s) 102 of the grill 100. For example, a first one of the ignitor(s) 108 can be located adjacent a corresponding first one of the burner(s) 102 at a position that enables the first one of the ignitor(s) 108 to ignite combustible gas as the gas emanates from within the corresponding first one of the burner(s) 102 via apertures formed in the corresponding first one of the burner(s) 102. In some such examples, the grill 100 includes a crossover ignition tube that facilitates transferring the ignited combustible gas (e.g., transferring the flame) from the corresponding first one of the burner(s) 102 discussed above to other ones of the burner(s) 102 of the grill 100. In other examples, the grill 100 includes multiple ones of the ignitor(s) 108, with respective ones of the ignitor(s) being mechanically coupled and/or operatively positioned relative to corresponding respective ones of the burner(s) 102 of the grill 100 (e.g., a first ignitor operatively positioned relative to a first burner, a second ignitor operatively positioned relative to a second burner, etc.).

In some examples, one or more of the ignitor(s) 108 of the grill 100 is/are implemented as a manually-operable ignitor that is configured to generate sparks (e.g., via a spark electrode of the ignitor) and/or otherwise induces ignition of the combustible gas in response to a user interacting with an ignition button that is operatively coupled to the ignitor. In some examples, one or more of the ignitor(s) 108 of the grill 100 is/are operatively coupled to (e.g., in electrical communication with) the controller 132 of the grill 100, with respective ones of the ignitor(s) 108 being configured to generate sparks (e.g., via a spark electrode of the ignitor) and/or otherwise induce ignition of the combustible gas in response to an instruction, a command, and/or a signal generated by the controller 132. In some examples, one or more of the ignitor(s) 108 of the grill 100 can be structured, configured, and/or implemented as one of the various ignitors described in U.S. patent application Ser. No. 17/144,038, filed on Jan. 7, 2021. In such examples, the ignitor(s) 108 can be mechanically coupled to corresponding ones of the burner(s) 102 via a ceramic harness as described in U.S. patent application Ser. No. 17/144,038. The entirety of U.S. patent application Ser. No. 17/144,038 is hereby incorporated by reference herein.

The cooking surface(s) 110 of the grill 100 of FIG. 1 can be implemented by any number(s), any type(s), and/or any configuration(s) of cooking surface(s). The cooking surface(s) 110 is/are configured to support and/or carry one or more item(s) of food to be warmed and/or cooked by the burner(s) 102 of the grill 100. In some examples, one or more of the cooking surface(s) 110 is/are implemented by and/or as a grate (e.g., a grilling grate, a searing grate, etc.), a rack (e.g., a warming rack), a cooking stone (e.g., a pizza stone), a griddle (e.g., a flattop griddle), a cooking vessel (e.g., a basket, a pot, a Dutch oven, a wok, etc.), and/or a rotisserie system (e.g., a rotisserie spit) located within and/or supported by the cookbox of the grill 100. In some examples, one or more of the cooking surface(s) 110 is/are implemented by and/or as a grate (e.g., a burner grate), a griddle (e.g., a flattop griddle), and/or a cooking vessel (e.g., a basket, a pot, a Dutch oven, a wok, etc.) located outside of the cookbox of the grill 100. For example, one or more of the cooking surface(s) 110 can be implemented by and/or as a grate (e.g., a burner grate), a griddle (e.g., a flattop griddle), and/or a cooking vessel (e.g., a basket, a pot, a Dutch oven, a wok, etc.) located on and/or supported by one of the table(s) (e.g., a side table) of the grill 100.

The lighting module(s) 112 of the grill 100 of FIG. 1 can be implemented by any number(s), any type(s), and/or any configuration(s) of lighting module(s). The lighting module(s) 112 is/are configured to project light (e.g., emitted from an incandescent, a halogen, or a LED light source) to or toward one or more structure(s) of the grill 100 including, for example, the cookbox, the cooking chamber, the cooking surface(s) 110, the control panel, one or more of the control knob(s), one or more of the control button(s), the cabinet, one or more of the table(s), and/or the user interface 122 of the grill 100. In some examples, one or more of the lighting modules(s) 112 of the grill 100 is/are implemented as a manually-operable lighting module that is configured to transition from an off state (e.g., a non-light projecting state) to an on state (e.g., a light projecting state), and vice-versa, in response to a user interacting with a control button and/or a control switch of the grill 100. In some examples, one or more of the lighting module(s) 112 of the grill 100 is/are implemented as a controllable electric lighting module that is configured to transition from an off state (e.g., a non-light projecting state) to an on state (e.g., a light projecting state), and vice-versa, in response to instructions, commands, and/or signals (e.g., a supply of current) generated by the controller 132 of the grill 100.

The temperature sensor(s) 114 of the grill 100 of FIG. 1 can be implemented by any number(s), any type(s), and/or any configuration(s) of temperature sensor(s). The temperature sensor(s) 114 is/are configured to sense, measure, and/or detect the temperature within the cooking chamber of the grill 100, the internal temperature of an item of food, and/or an ambient temperature. In some examples, one or more of the temperature sensor(s) 114 is/are implemented by and/or as a thermocouple coupled to either the cookbox or the lid of the grill 100, and positioned in and/or extending into the cooking chamber of the grill 100. In some examples, one or more of the temperature sensor(s) 114 is/are implemented by and/or as a temperature gauge coupled to either the cookbox or the lid of the grill 100, and positioned in and/or extending into the cooking chamber of the grill 100. In some examples, one or more of the temperature sensor(s) 114 is/are implemented by and/or as a food temperature probe to be inserted into an item of food. In some examples, one or more of the temperature sensor(s) 114 is/are implemented by and/or as an ambient temperature probe coupled to one of the cooking surface(s) 110 of the grill 100, and positioned in the cooking chamber of the grill 100. Data, information, and/or signals sensed, measured, and/or detected by the temperature sensor(s) 114 of FIG. 1 can be of any quantity, type, form, and/or format. In some examples, data, information, and/or signals sensed, measured, and/or detected by the temperature sensor(s) 114 of FIG. 1 can be transmitted directly to the controller 132 of FIG. 1, and/or can be transmitted to and stored in the main memory 140 of FIG. 1.

The flame sensor(s) 116 of the grill 100 of FIG. 1 can be implemented by any number(s), any type(s), and/or any configuration(s) of flame sensor(s). The flame sensor(s) 116 is/are configured to sense, measure, and/or detect the presence and/or the absence of a flame emanating from one or more of the burner(s) 102 of the grill 100. In some examples, one or more of the flame sensor(s) 116 of the grill 100 can be structured, configured, and/or implemented as one of the various flame sensors described in U.S. patent application Ser. No. 17/144,038, filed on Jan. 7, 2021. The entirety of U.S. patent application Ser. No. 17/144,038 is hereby incorporated by reference herein. Data, information, and/or signals sensed, measured, and/or detected by the flame sensor(s) 116 of FIG. 1 can be of any quantity, type, form, and/or format. In some examples, data, information, and/or signals sensed, measured, and/or detected by the flame sensor(s) 116 of FIG. 1 can be transmitted directly to the controller 132 of FIG. 1, and/or can be transmitted to and stored in the main memory 140 of FIG. 1.

The lid position sensor(s) 118 of the grill 100 of FIG. 1 can be implemented by any number(s), any type(s), and/or any configuration(s) of lid position sensor(s). The lid position sensor(s) 118 is/are configured to sense, measure, and/or detect a position (e.g., a closed position, an open position, and/or any position therebetween) and/or a change in position (e.g., movement) of the lid of the grill 100. In some examples, one or more of the lid position sensor(s) 118 is/are implemented by and/or as a contact sensor (e.g., a limit switch) having one or more component(s) coupled to the cookbox, the lid, the handle, the frame, the cabinet, the control panel, and/or one of the table(s) of the grill 100. In some examples, one or more of the lid position sensor(s) 118 is/are implemented by and/or as a proximity sensor (e.g., a proximity switch) having one or more component(s) coupled to the cookbox, the lid, the handle, the frame, the cabinet, the control panel, and/or one of the table(s) of the grill 100. In some examples, one or more of the lid position sensor(s) 118 is/are implemented by and/or as an accelerometer having one or more component(s) coupled to the lid or the handle of the grill 100. In some examples, one or more of the lid position sensor(s) 118 is/are implemented by and/or as an optical sensor (e.g., an optical switch) having one or more component(s) coupled to the cookbox, the lid, the handle, the frame, the cabinet, the control panel, and/or one of the table(s) of the grill 100. In some examples, one or more of the lid position sensor(s) 118 is/are implemented by and/or as a Bowden cable connected switch having one or more component(s) coupled to the cookbox, the lid, the handle, the frame, the cabinet, the control panel, and/or one of the table(s) of the grill 100. Data, information, and/or signals sensed, measured, and/or detected by the lid position sensor(s) 118 of FIG. 1 can be of any quantity, type, form, and/or format. In some examples, data, information, and/or signals sensed, measured, and/or detected by the lid position sensor(s) 118 of FIG. 1 can be transmitted directly to the controller 132 of FIG. 1, and/or can be transmitted to and stored in the main memory 140 of FIG. 1.

The fuel level sensor(s) 120 of the grill 100 of FIG. 1 can be implemented by any number(s), any type(s), and/or any configuration(s) of fuel level sensor(s). The fuel level sensor(s) 120 is/are configured to sense, measure, and/or detect the level and/or amount of fuel remaining in the fuel source 106 of the grill 100. In some examples, one or more of the fuel level sensor(s) 120 is/are implemented by and/or as a scale (e.g., a tank scale) coupled to the cookbox, the frame, the cabinet, or one of the table(s) of the grill 100, with the scale being configured to weigh the fuel source 106 of the grill 100. In some examples, one or more of the fuel level sensor(s) 120 is/are implemented by and/or as a pressure gauge operatively positioned (e.g., within a gas train of the grill 100) between the fuel source 106 and the manifold of the grill 100. Data, information, and/or signals sensed, measured, and/or detected by the fuel level sensor(s) 120 of FIG. 1 can be of any quantity, type, form, and/or format. In some examples, data, information, and/or signals sensed, measured, and/or detected by the fuel level sensor(s) 120 of FIG. 1 can be transmitted directly to the controller 132 of FIG. 1, and/or can be transmitted to and stored in the main memory 140 of FIG. 1.

The user interface 122 of the grill 100 of FIG. 1 includes one or more input device(s) 124 (e.g., buttons, dials, knobs, switches, touchscreens, etc.) and/or one or more output device(s) 126 (e.g., liquid crystal displays, light emitting diodes, speakers, etc.) that enable a user of the grill 100 to interact with the above-described control system of the grill 100. In the illustrated example of FIG. 1, the user interface 122 is operatively coupled to (e.g., in wired or wireless electrical communication with) the network interface 128, the controller 132, and/or the main memory 140 of the grill 100. In some examples, the user interface 122 is mechanically coupled to (e.g., fixedly connected to) the grill 100. For example, the user interface 122 can be mounted to the cookbox, the lid, the handle, the frame, the cabinet, the control panel, and/or one of the table(s) of the grill 100. The user interface 122 is preferably mounted to a portion of the grill 100 that is readily accessible to a user of the grill 100, such as a front portion of the cookbox, the lid, the handle, the frame, the cabinet, the control panel, and/or one of the table(s) of the grill 100. In some examples, respective ones of the input device(s) 124 and/or the output device(s) 126 of the user interface 122 can be mounted to different portions of the grill 100. For example, a first one of the input device(s) 124 can be mounted to a side portion of either the cookbox, the lid, the handle, the frame, the cabinet, the control panel, or one of the table(s) of the grill 100, and a second one of the input device(s) 124 can be mounted to a front portion of either the cookbox, the lid, the handle, the frame, the cabinet, the control panel, or one of the table(s) of the grill 100. The architecture and/or operations of the user interface 122 can be distributed among any number of user interfaces respectively having any number of input device(s) 124 and/or output device(s) 126 located at and/or mounted to any portion of the grill 100.

In some examples, one or more user input(s), selection(s), instruction(s), command(s) and/or interaction(s) can be received via the input device(s) 124 of the user interface 122 in connection with the selection and/or the implementation of one or more selectable cook programs to be implemented via the control system of the grill 100. For example, one or more user input(s), selection(s), instruction(s), command(s) and/or interaction(s) received via the input device(s) 124 of the user interface 122 may be indicative of a user-based selection of a cook program from among a library of selectable cook programs that are available for implementation via the control system of the grill 100. As another example, one or more user input(s), selection(s), instruction(s), command(s) and/or interaction(s) received via the input device(s) 124 of the user interface 122 may be indicative of a user-based confirmation (or override) input associated with the performance of a user-based step, and/or associated with the performance of a cooking operation that requires a user-based step, in connection with a selected cook program being implemented via the control system of the grill 100.

In some examples, one or more notification(s) (e.g., one or more visible, audible, and/or tactile message(s) or alert(s)) can be presented via the output device(s) 126 of the user interface 122 in connection with the selection and/or the implementation of one or more selectable cook programs to be implemented via the control system of the grill 100. For example, one or more notification(s) (e.g., one or more visible, audible, and/or tactile message(s) or alert(s)) presented via the output device(s) 126 of the user interface 122 may inform the user of the grill 100 that a plurality of cook programs are available for selection and/or implementation. As another example, one or more notification(s) presented via the output device(s) 126 of the user interface 122 may inform the user of the grill 100 that a particular cook program has been selected for implementation. As another example, one or more notification(s) presented via the output device(s) 126 of the user interface 122 may inform the user of the grill 100 that the selected cooking program being implemented via the control system of the grill 100 has advanced to a user-based step, and/or to a cooking operation that requires a user-based step. As another example, one or more notification(s) presented via the output device(s) 126 of the user interface 122 may inform the user of the grill 100 that a user-based step, and/or a cooking operation that requires a user-based step, is/are due to be performed in connection with the selected cook program being implemented via the control system of the grill 100. As another example, one or more notification(s) presented via the output device(s) 126 of the user interface 122 may inform the user of the grill 100 that a user-based step, and/or a cooking operation that requires a user-based step, has/have been performed in connection with the selected cook program being implemented via the control system of the grill 100.

The network interface 128 of the grill 100 of FIG. 1 includes one or more communication device(s) 130 (e.g., transmitter(s), receiver(s), transceiver(s), modem(s), gateway(s), wireless access point(s), etc.) to facilitate exchange of data with external machines (e.g., computing devices of any kind, including the remote device(s) 148 of FIG. 1) by a wired or wireless communication network. Communications transmitted and/or received via the communication device(s) 130 and/or, more generally, via the network interface 128 can be made over and/or carried by, for example, an Ethernet connection, a digital subscriber line (DSL) connection, a telephone line connection, a coaxial cable system, a satellite system, a wireless system, a cellular telephone system, an optical connection, etc. The network interface 128 enables a user of the grill 100 to remotely interact (e.g., via one or more of the remote device(s) 148) with the above-described control system of the grill 100. In the illustrated example of FIG. 1, the network interface 128 is operatively coupled to (e.g., in electrical communication with) the user interface 122, the controller 132, and/or the main memory 140 of the grill 100.

The remote device(s) 148 of FIG. 1 can be implemented by any number(s) and/or any type(s) of mobile or stationary computing devices. Examples of such remote device(s) 148 include a smartphone, a tablet, a laptop, a desktop, a cloud server, a wearable computing device, etc. In some examples, one or more of the remote device(s) 148 of FIG. 1 facilitate(s) a remote (e.g., wired, or wireless) extension of the above-described user interface 122 of the grill 100. In this regard, one or more of the remote device(s) 148 include(s) one or more input device(s) and/or one or more output device(s) that mimic and/or enable a remotely-located version of the above-described functionality of the corresponding input device(s) 124 and/or the corresponding output device(s) 126 of the user interface 122 of the grill 100. Accordingly, one or more user input(s), selection(s), instruction(s), command(s) and/or interaction(s) generated via the input device(s) of the remote device(s) 148 can be received at the grill 100 (e.g., via the communication device(s) 130 of the network interface 128 of the grill 100) in connection with the selection and/or the implementation of one or more selectable cook programs to be implemented via the control system of the grill 100. In this same regard, one or more notification(s) (e.g., one or more visible, audible, and/or tactile message(s) or alert(s)) transmitted from the grill 100 (e.g., via the communication device(s) 130 of the network interface 128 of the grill 100) can be presented via the output device(s) of the remote device(s) 148 in connection with the selection and/or the implementation of one or more selectable cook programs to be implemented via the control system of the grill 100.

The controller 132 of the grill 100 of FIG. 1 manages and/or controls the control system of the grill 100 and/or the components thereof. In the illustrated example of FIG. 1, the controller 132 is operatively coupled to (e.g., in wired or wireless electrical communication with) the user interface 122 (e.g., including the input device(s) 124 and the output device(s) 126), the network interface 128 (e.g., including the communication device(s) 130), and/or the main memory 140 of the grill 100 of FIG. 1. The controller 132 is also operatively coupled to (e.g., in wired or wireless electrical communication with) the remote device(s) 148 of FIG. 1 via the network interface 128 (e.g., including the communication device(s) 130) of the grill 100 of FIG. 1. In some examples, the controller 132 is also operatively coupled to (e.g., in wired or wireless electrical communication with) one or more of the valve(s) 104, one or more of the ignitor(s) 108, one or more of the lighting module(s) 112, one or more of the temperature sensor(s) 114, one or more of the flame sensor(s) 116, one or more of the lid position sensor(s) 118, and/or one or more of the fuel level sensor(s) 120. In the illustrated example of FIG. 1, the controller 132 includes the control circuitry 134 and the detection circuitry 136 of FIG. 1, each of which is discussed in further detail herein. The control circuitry 134, the detection circuitry 136, and/or, more generally, the controller 132 of FIG. 1 can individually and/or collectively be implemented by any type(s) and/or any number(s) of semiconductor device(s) (e.g., processor(s), microprocessor(s), microcontroller(s), etc.) and/or circuit(s).

In the illustrated example of FIG. 1, the controller 132 is graphically represented as a single, discrete structure that manages and/or controls the operation(s) of various components of the control system of the grill 100. It is to be understood, however, that in other examples, the architecture and/or operations of the controller 132 can be distributed among any number of controllers, with each separate controller having a dedicated subset of one or more operation(s) described herein. As but one example, the controller 132 of FIG. 1 can be separated into two distinct controllers, whereby a first one of the two controllers includes the control circuitry 134 of the controller 132, and a second one of the two controllers includes the detection circuitry 136 of the controller 132. In some examples, the grill 100 can further include separate, distinct controllers for one or more of the valve(s) 104, the ignitor(s) 108, the lighting module(s) 112, the temperature sensor(s) 114, the flame sensor(s) 116, the lid position sensor(s) 118, the fuel level sensor(s) 120, the user interface 122, the network interface 128, and/or the main memory 140 of the grill 100.

The controller 132 of FIG. 1 manages and/or controls the selection and implementation of cook programs for the grill 100 of FIG. 1. In this regard, one or more cook program(s) to be implemented via the controller 132 and/or, more generally, via the control system of the grill 100 can be selected (e.g., by a user of the grill 100) from among a library of selectable cook programs that are available for implementation. In some examples, the controller 132 determines whether a cook program selection has been received at the grill 100. For example, the controller 132 may determine that a cook program selection has been received based on a user input, a user selection, and/or a user interaction (e.g., a press, a push, a pull, a rotation, a click, a flip, etc.) of, to, and/or with one or more of the input device(s) 124 (e.g., a button, a dial, a knob, a switch, a touchscreen, etc.) of the user interface 122 of FIG. 1. As another example, the controller 132 may determine that a cook program selection has been received based on a user input, a user selection, and/or a user interaction (e.g., a press, a push, a pull, a rotation, a click, a flip, etc.) of, to, and/or with one or more input device(s) (e.g., a button, a dial, a knob, a switch, a touchscreen, etc.) of one of the remote device(s) 148 of FIG. 1, as received and/or detected via the network interface 128 of FIG. 1. In response to determining that a cook program selection has been received at the grill 100, the controller 132 invokes the control circuitry 134 and/or the detection circuitry 136 of FIG. 1 to implement (e.g., execute) the selected cook program via the control system of the grill 100, as further described herein.

The control circuitry 134 of the controller 132 of FIG. 1 manages and/or controls one or more operation(s) of one or more controllable component(s) of the grill 100 that is/are operatively coupled to (e.g., in electrical communication with) the controller 132 of the grill 100. For example, the control circuitry 134 may include valve control circuitry configured to instruct, command, signal, and/or otherwise cause one or more of the valve(s) 104 of the grill 100 to open (e.g., fully open), to close (e.g., fully close), or to otherwise change position. The control circuitry 134 may additionally or alternatively include ignitor control circuitry configured to instruct, command, signal, and/or otherwise cause one or more of the ignitor(s) 108 of the grill 100 to ignite one or more of the burner(s) 102 of the grill 100. The control circuitry 134 may additionally or alternatively include lighting control circuitry configured to instruct, command, signal, and/or otherwise cause one or more of the lighting module(s) 112 of the grill 100 to transition from an off state (e.g., a non-light projecting state) to an on state (e.g., a light projecting state), or vice-versa.

The control circuitry 134 may additionally or alternatively include user interface control circuitry configured to instruct, command, signal, and/or otherwise cause one or more of the output device(s) 126 of the user interface 122 of the grill 100 to present data and/or information, which may include one or more notification(s) (e.g., one or more visible, audible, and/or tactile message(s) or alert(s)). The control circuitry 134 may additionally or alternatively include network interface control circuitry configured to instruct, command, signal, and/or otherwise cause one or more of the communication device(s) 130 of the network interface 128 of the grill 100 to transmit data and/or information, which may include one or more notification(s) (e.g., one or more visible, audible, and/or tactile message(s) or alert(s)), to one or more of the remote device(s) 148 of FIG. 1. The control circuitry 134 may additionally or alternatively include dongle control circuitry configured to instruct, command, signal, and/or otherwise cause data and/or information stored in and/or on the memory 144 of the dongle 142 to be read by the controller 132 and/or transferred to one or more of the user interface 122, the network interface 128, the controller 132, and/or the main memory 140 of the grill 100.

The control circuitry 134 may additionally or alternatively include cook program control circuitry configured to manage and/or guide one or more operation(s) of one or more other component(s) of the control circuitry 134 (e.g., the valve control circuitry, the ignitor control circuitry, the lighting module control circuitry, the user interface control circuitry, the network interface control circuitry, and/or the dongle control circuitry) in connection with implementing (e.g., executing) and/or guiding a selected cook program (e.g., the ordered steps of a cook program specified by and/or otherwise corresponding to the cook program selection received at the grill 100). In this regard, the cook program control circuitry manages and/or controls the advancement and/or progression of a series of ordered steps of the cook program beginning with a first step and continuing through a last step.

The control circuitry 134 may additionally or alternatively include registration control circuitry configured to manage and/or guide one or more operation(s) of one or more other component(s) of the control circuitry 134 (e.g., the user interface control circuitry, the network interface control circuitry, and/or the dongle control circuitry) in connection with implementing (e.g., executing) and/or guiding a registration process associated with the grill 100. In this regard, the registration control circuitry manages and/or controls the advancement and/or progression of a series of ordered steps of the registration process beginning with a first step and continuing through a last step.

The detection circuitry 136 of the controller 132 of FIG. 1 detects and/or determines one or more state(s), condition(s), operation(s), and/or event(s) associated with the grill 100 based on data, information, and/or signals received from one or more component(s) of the grill 100 that is/are operatively coupled to (e.g., in wired or wireless electrical communication with) the controller 132 of the grill 100. For example, the detection circuitry 136 may include temperature detection circuitry configured to detect and/or determine one or more temperature state(s), condition(s), operation(s), and/or event(s) associated with the grill 100 (e.g., that a cooking chamber temperature is within a threshold range associated with a setpoint temperature, that a cooking chamber temperature has fallen outside of a threshold range associated with a setpoint temperature, that a food item temperature has reached a desired temperature, etc.) based on data, information, and/or signals received from one or more of the temperature sensor(s) 114 of the grill 100.

The detection circuitry 136 may additionally or alternatively include flame detection circuitry configured to detect and/or determine the presence or the absence of a flame at one or more of the burner(s) 102 of the grill 100 based on data, information, and/or signals received from one or more of the flame sensor(s) 116 of the grill 100. The detection circuitry 136 may additionally or alternatively include lid position detection circuitry configured to detect and/or determine one or more lid position state(s), condition(s), operation(s), and/or event(s) associated with the lid of the grill 100 (e.g., that the lid is in a closed position, that the lid is in an open position, that the lid has moved from a closed position to or toward an open position, etc.) based on data, information, and/or signals received from one or more of the lid position sensor(s) 118 of the grill 100. The detection circuitry 136 may additionally or alternatively include fuel level detection circuitry configured to detect and/or determine one or more fuel level state(s), condition(s), operation(s), and/or event(s) associated with the fuel source 106 of the grill 100 (e.g., that a fuel level is above a threshold fuel level, that a fuel level has fallen below a threshold fuel level etc.) based on data, information, and/or signals received from one or more of the fuel level sensor(s) 120 of the grill 100.

The detection circuitry 136 may additionally or alternatively include user interface detection circuitry configured to detect and/or determine one or more user interface state(s), condition(s), operation(s), and/or event(s) associated with the grill 100 (e.g., that a user has interacted with one or more of the input device(s) 124 of the user interface 122, that a user has failed to interact with one or more of the input device(s) 124 of the user interface 122, etc.) based on data, information, and/or signals received from the user interface 122 of the grill 100. The detection circuitry 136 may additionally or alternatively include network interface detection circuitry configured to detect and/or determine one or more network interface state(s), condition(s), operation(s), and/or event(s) associated with the grill 100 (e.g., that one or more of the communication device(s) 130 of the network interface has received data, information, and/or signals indicating that a user has interacted with one or more input device(s) of one or more of the remote device(s) 148, that one or more of the communication device(s) 130 of the network interface has failed to receive data, information, and/or signals indicating that a user has interacted with one or more input device(s) of one or more of the remote device(s) 148, etc.) based on data, information, and/or signals received from the network interface 128 of the grill 100. The detection circuitry 136 may additionally or alternatively include dongle detection circuitry configured to detect and/or determine one or more state(s), condition(s), operation(s), and/or event(s) associated with the dongle 142 of the grill 100 (e.g., that the dongle 142 is connected to the socket 138 of the controller 132, that the dongle 142 is not connected to the socket 138 of the controller 132, that data and/or information stored in and/or on the memory 144 of the dongle 142 has been read by the controller 132 and/or transferred to one or more of the user interface 122, the network interface 128, the controller 132, and/or the main memory 140 of the grill 100, etc.).

The detection circuitry 136 may additionally or alternatively include cook program detection circuitry configured to manage and/or guide one or more operation(s) of one or more other component(s) of the detection circuitry 136 (e.g., the temperature detection circuitry, the flame detection circuitry, the lid position detection circuitry, the fuel level valve detection circuitry, the user interface detection circuitry, the network interface detection circuitry, and/or the dongle detection circuitry) in connection with implementing (e.g., executing) and/or guiding a selected cook program (e.g., the ordered steps of a cook program specified by and/or otherwise corresponding to the cook program selection received at the grill 100). In this regard, the cook program detection circuitry may detect and/or determine one or more cook program state(s), condition(s), operation(s), and/or event(s) associated with the grill 100 (e.g., the selection of a cook program, the start of a cook program, the completion of a step of a cook program, the end of a cook program, etc.) based on data, information, and/or signals received from one or more of the temperature sensor(s) 114, one or more of the flame sensor(s) 116, one or more of the lid position sensor(s) 118, one or more of the fuel level sensor(s) 120, the user interface 122, the network interface 128, and/or the dongle 142 of the grill 100. The cook program detection circuitry may relay the detected and/or determined cook program state(s), condition(s), operation(s), and/or event(s) to the cook program control circuitry described above in connection with the cook program control circuitry managing and/or controlling the advancement and/or progression of a series of ordered steps of the cook program beginning with a first step and continuing through a last step.

The detection circuitry 136 may additionally or alternatively include registration detection circuitry configured to manage and/or guide one or more operation(s) of one or more other component(s) of the detection circuitry 136 (e.g., the user interface detection circuitry, the network interface detection circuitry, and/or the dongle detection circuitry) in connection with implementing (e.g., executing) and/or guiding a registration process associated with the grill 100. In this regard, the registration detection circuitry may detect and/or determine one or more registration state(s), condition(s), operation(s), and/or event(s) associated with the grill 100 (e.g., the start of a registration process, the completion of a step of a registration process, the end of a registration process, etc.) based on data, information, and/or signals received from the user interface 122, the network interface 128, and/or the dongle 142 of the grill 100. The registration detection circuitry may relay the detected and/or determined registration state(s), condition(s), operation(s), and/or event(s) to the registration control circuitry described above in connection with the registration control circuitry managing and/or controlling the advancement and/or progression of a series of ordered steps of the registration process beginning with a first step and continuing through a last step.

The main memory 140 of the grill 100 of FIG. 1 can be implemented by any type(s) and/or any number(s) of storage device(s) such as a storage drive, a flash memory, a read-only memory (ROM), a random-access memory (RAM), a cache and/or any other physical storage medium in which information is stored for any duration (e.g., for extended time periods, permanently, brief instances, for temporarily buffering, and/or for caching of the information). The information stored in the main memory 140 of FIG. 1 can be stored in any file and/or data structure format, organization scheme, and/or arrangement.

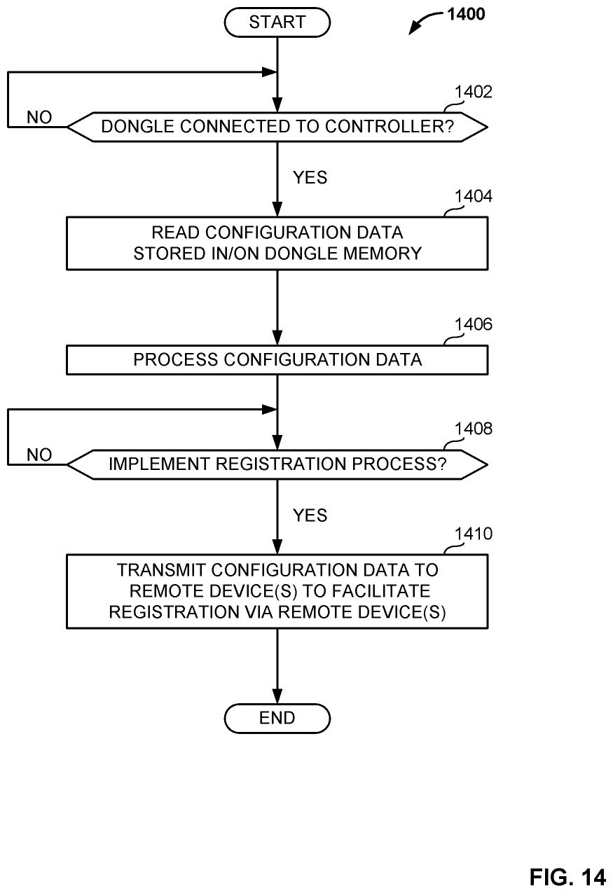

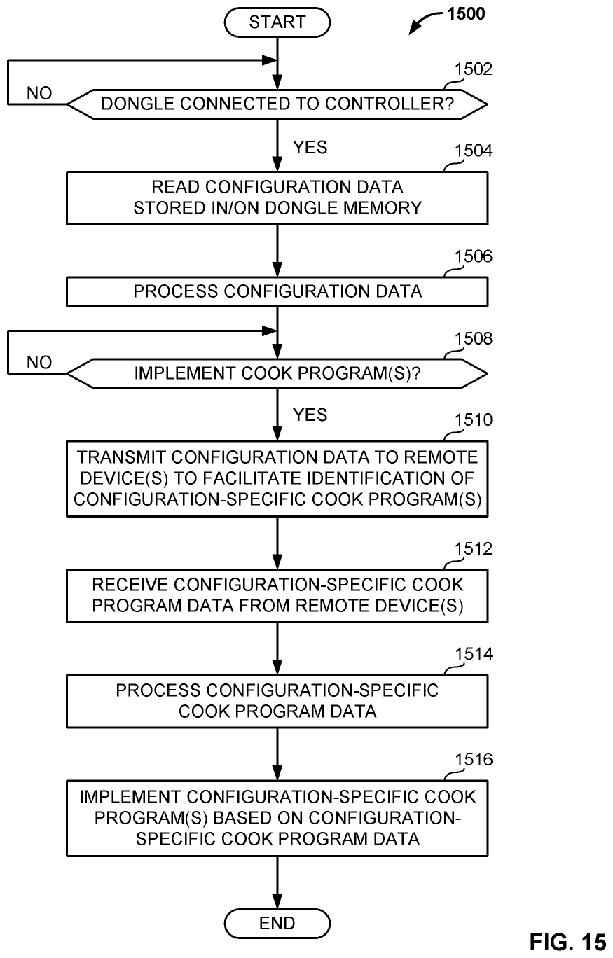

The main memory 140 of FIG. 1 stores data sensed, measured, detected, generated, input, output, transmitted, and/or received by, to, and/or from the user interface 122 (e.g., including the input device(s) 124 and the output device(s) 126), the network interface 128 (e.g., including the communication device(s) 130), the controller 132 (e.g., including the control circuitry 134 and the detection circuitry 136), the dongle 142 (e.g., including the memory 144), the remote device(s) 148, and/or, more generally, the control system of the grill 100 of FIG. 1. In some examples, the main memory 140 also stores data sensed, measured, detected, generated, input, output, transmitted, and/or received by, to, and/or from one or more of the valve(s) 104, one or more of the ignitor(s) 108, one or more of the lighting module(s) 112, one or more of the temperature sensor(s) 114, one or more of the flame sensor(s) 116, one or more of the lid position sensor(s) 118, and/or one or more of the fuel level sensor(s) 120. In some examples, the main memory 140 also stores instructions (e.g., machine-readable instructions) and associated data corresponding to one or more cook program(s) to be implemented via the control system of the grill 100 of FIG. 1, and/or corresponding to the processes, protocols, sequences, and/or methods described below in connection with FIGS. 14 and 15.

The main memory 140 of FIG. 1 is accessible to one or more of the user interface 122 (e.g., including the input device(s) 124 and the output device(s) 126), the network interface 128 (e.g., including the communication device(s) 130), the controller 132 (e.g., including the control circuitry 134 and the detection circuitry 136), the remote device(s) 148, and/or, more generally, the control system of the grill 100 of FIG. 1. In some examples, the main memory 140 is also accessible to one or more of the valve(s) 104, one or more of the ignitor(s) 108, one or more of the lighting module(s) 112, one or more of the temperature sensor(s) 114, one or more of the flame sensor(s) 116, one or more of the lid position sensor(s) 118, and/or one or more of the fuel level sensor(s) 120.

The dongle 142 of the grill 100 of FIG. 1 is a portable memory device that is separate from the main memory 140 of the grill 100 and selectively connectable (e.g., by a user) to the controller 132 of the grill 100. In this regard, the dongle 142 becomes operatively coupled to (e.g., in electrical communication with) the controller 132 when the plug 146 of the dongle 142 is physically connected (e.g., by a user) to the socket 138 of the controller 132. The physical and electrical connections between the plug 146 and the socket 138, and/or, more generally, between the dongle 142 and the controller 132, can be implemented by any known physical and/or electrical connectors. In some examples, the dongle 142 is mechanically coupled to (e.g., fixedly connected to) the grill 100. For example, the dongle 142 can be mounted to the cookbox, the lid, the handle, the frame, the cabinet, the control panel, and/or one of the table(s) of the grill 100. The dongle 142 is preferably mounted to a portion of the grill 100 that advantageously enables the plug 146 of the dongle 142 to be connected to and/or disconnected from the socket 138 of the controller 132 without removing the dongle 142 and the controller 132 from their respective fixed mounting positions relative to the grill 100. For example, the dongle 142 and the controller 132 may both be mechanically coupled (e.g., fixedly connected to) and located along an underside of one of the table(s) of the grill 100.

The memory 144 of the dongle 142 of FIG. 1 can be implemented by any type(s) and/or any number(s) of storage device(s) such as a storage drive, a flash memory, a read-only memory (ROM), a random-access memory (RAM), a cache and/or any other physical storage medium in which information is stored for any duration (e.g., for extended time periods, permanently, brief instances, for temporarily buffering, and/or for caching of the information). The information stored in the memory 144 of the dongle 142 can be stored in any file and/or data structure format, organization scheme, and/or arrangement.

The memory 144 of the dongle 142 of FIG. 1 stores configuration data that identifies the presence (or the absence), the location, the orientation, the layout, the arrangement, the number, the size, the type, and/or the functional capability of one or more component(s) of the grill 100. In some examples, the configuration data includes a unique identification number or code (e.g., a product serial number for the grill 100) that uniquely identifies the grill 100. The memory 144 of the dongle 142 becomes accessible to the controller 132 of the grill 100 in response to the plug 146 of the dongle 142 being connected to the socket 138 of the controller 132. As described above, the detection circuitry 136 of the controller 132 detects and/or determines whether the dongle 142 is connected to the controller 132 (e.g., whether the plug 146 of the dongle 142 is connected to the socket 138 of the controller 132). In response to the controller 132 determining that the dongle 142 is connected, the control circuitry 134 of the controller 132 instructs, commands, signals, and/or otherwise causes data and/or information stored in and/or on the memory 144 of the dongle 142 to be read by the controller 132, and/or to be transferred to one or more of the user interface 122, the network interface 128, the controller 132, and/or the main memory 140 of the grill 100.

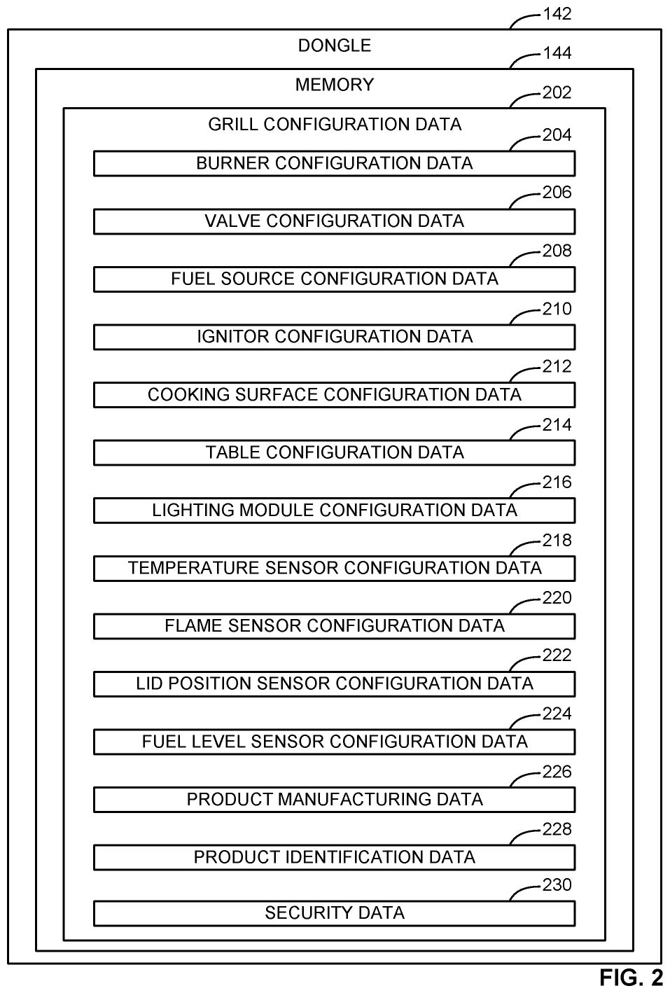

FIG. 2 a block diagram of the memory 144 of the dongle 142 of FIG. 1. In the illustrated example of FIG. 2, the memory 144 of the dongle 142 stores example grill configuration data 202 associated with the grill 100 of FIG. 1. The grill configuration data 202 of FIG. 2 is written to and/or stored in and/or on the memory 144 of the dongle 142 (e.g., by a manufacturer of the grill 100) prior to the dongle 142 being connected to the controller 132 of the grill 100. For example, the grill configuration data 202 can be written to and/or stored in and/or on the memory of the dongle 142 on the production floor, prior to the grill 100 being fully assembled, and/or prior to the grill 100 being packaged for sale and/or shipped to a consumer. In the illustrated example of FIG. 2, the grill configuration data 202 includes example burner configuration data 204, example valve configuration data 206, example fuel source configuration data 208, example ignitor configuration data 210, example cooking surface configuration data 212, example table configuration data 214, example lighting module configuration data 216, example temperature sensor configuration data 218, example flame sensor configuration data 220, example lid position sensor configuration data 222, example fuel level sensor configuration data 224, example product manufacturing data 226, example product identification data 228, and example security data 230. In other examples, the grill configuration data 202 may include additional, fewer, or alternative types and/or categories of data.

The burner configuration data 204 of FIG. 2 identifies and/or otherwise indicates one or more of the presence (or the absence), the location, the orientation, the layout, the arrangement, the number, the size, the type, and/or the functional capability of one or more of the burner(s) 102 of the grill 100. In some examples, the burner configuration data 204 may identify and/or indicate whether the grill 100 includes one or more searing burner(s) (e.g., a searing station), one or more infrared burner(s), and/or one or more side burner(s) in addition to any main burner(s) of the grill 100.

The valve configuration data 206 of FIG. 2 identifies and/or otherwise indicates one or more of the presence (or the absence), the location, the orientation, the layout, the arrangement, the number, the size, the type, and/or the functional capability of one or more of the valve(s) 104 of the grill 100. In some examples, the valve configuration data 206 may identify and/or indicate whether the grill 100 includes one or more controllable electric valve(s) (e.g., configured to be operatively coupled to the controller 132 of the grill 100) in addition to any manually-operable valve(s) of the grill 100.

The fuel source configuration data 208 of FIG. 2 identifies and/or otherwise indicates one or more of the presence (or the absence), the location, the orientation, the layout, the arrangement, the size, the type, and/or the functional capability of the fuel source 106 of the grill 100. In some examples, the fuel source configuration data 208 may identify and/or indicate whether the grill 100 is to be connected to a fuel tank (e.g., a propane tank) containing combustible gas, or whether the grill is instead to be connected to a piped (e.g., household) natural gas line that provides an accessible flow of combustible gas.

The ignitor configuration data 210 of FIG. 2 identifies and/or otherwise indicates one or more of the presence (or the absence), the location, the orientation, the layout, the arrangement, the number, the size, the type, and/or the functional capability of one or more of the ignitor(s) 108 of the grill 100. In some examples, the ignitor configuration data 210 may identify and/or indicate whether the grill 100 includes one or more controllable electric ignitor(s) (e.g., configured to be operatively coupled to the controller 132 of the grill 100) in addition to any manually-operable ignitor(s) of the grill 100.

The cooking surface configuration data 212 of FIG. 2 identifies and/or otherwise indicates one or more of the presence (or the absence), the location, the orientation, the layout, the arrangement, the number, the size, the type, and/or the functional capability of one or more of the cooking surface(s) 110 of the grill 100. In some examples, the cooking surface configuration data 212 may identify and/or indicate whether the grill 100 includes one or more specialized grate(s) (e.g., a searing grate), rack(s) (e.g., a warming rack), cooking stone(s) (e.g., a pizza stone), griddle(s) (e.g., a flattop griddle), cooking vessel(s) (e.g., a basket, a pot, a Dutch oven, a wok, etc.), and/or rotisserie system(s) (e.g., a rotisserie spit) in addition to any main grilling grate(s) of the grill 100.

The table configuration data 214 of FIG. 2 identifies and/or otherwise indicates one or more of the presence (or the absence), the location, the orientation, the layout, the arrangement, the number, the size, the type, and/or the functional capability of one or more of the table(s) of the grill 100. In some examples, the table configuration data 214 may identify and/or indicate whether the grill 100 includes one or more side table(s) and/or one or more front table(s).

The lighting module configuration data 216 of FIG. 2 identifies and/or otherwise indicates one or more of the presence (or the absence), the location, the orientation, the layout, the arrangement, the number, the size, the type, and/or the functional capability of one or more of the lighting module(s) 112 of the grill 100. In some examples, the lighting module configuration data 216 may identify and/or indicate whether the grill 100 includes one or more controllable lighting module(s) (e.g., configured to be operatively coupled to the controller 132 of the grill 100) in addition to any manually-operable lighting module(s) of the grill 100.

The temperature sensor configuration data 218 of FIG. 2 identifies and/or otherwise indicates one or more of the presence (or the absence), the location, the orientation, the layout, the arrangement, the number, the size, the type, and/or the functional capability of one or more of the temperature sensor(s) 114 of the grill 100. In some examples, the temperature sensor configuration data 218 may identify and/or indicate whether the grill 100 includes one or more temperature gauge(s), one or more thermocouple(s), one or more food temperature probe(s), and/or one or more ambient temperature probe(s). In some examples, the temperature sensor configuration data 218 may identify and/or indicate whether the grill 100 includes one or more temperature sensor(s) configured to be operatively coupled to the controller 132 of the grill 100.

The flame sensor configuration data 220 of FIG. 2 identifies and/or otherwise indicates one or more of the presence (or the absence), the location, the orientation, the layout, the arrangement, the number, the size, the type, and/or the functional capability of one or more of the flame sensor(s) 116 of the grill 100. In some examples, the flame sensor configuration data 220 may identify and/or indicate whether the grill 100 includes one or more flame sensor(s) configured to be operatively coupled to the controller 132 of the grill 100.

The lid position sensor configuration data 222 of FIG. 2 identifies and/or otherwise indicates one or more of the presence (or the absence), the location, the orientation, the layout, the arrangement, the number, the size, the type, and/or the functional capability of one or more of the lid position sensor(s) 118 of the grill 100. In some examples, the lid position sensor configuration data 222 may identify and/or indicate whether the grill 100 includes one or more contact sensor(s), one or more proximity sensor(s), one or more accelerometer(s), one or more optical sensor(s), and/or one or more Bowden cable connected switch(es). In some examples, the lid position sensor configuration data 222 may identify and/or indicate whether the grill 100 includes one or more lid position sensor(s) configured to be operatively coupled to the controller 132 of the grill 100.

The fuel level sensor configuration data 224 of FIG. 2 identifies and/or otherwise indicates one or more of the presence (or the absence), the location, the orientation, the layout, the arrangement, the number, the size, the type, and/or the functional capability of one or more of the fuel level sensor(s) 120 of the grill 100. In some examples, the fuel level sensor configuration data 224 may identify and/or indicate whether the grill 100 includes one or more scale(s) and/or one or more pressure sensor(s) configured to measure, sense, and/or detect a fuel level of the fuel source 106 of the grill 100. In some examples, the fuel level sensor configuration data 224 may identify and/or indicate whether the grill 100 includes one or more fuel level sensor(s) configured to be operatively coupled to the controller 132 of the grill 100.

The product manufacturing data 226 of FIG. 2 identifies and/or otherwise indicates one or more of the manufacturer, the manufacturing date (e.g., the day, the month, and/or the year of manufacture) and/or the manufacturing location (e.g., the city, the state, the region, the country, and/or the continent of manufacture) of the grill 100.

The product identification data 228 of FIG. 2 identifies and/or otherwise indicates one or more of the make (e.g., the product line), the model (e.g., the product type), and/or the unique number or code (e.g., the product serial number) of the grill 100.

The security data 230 of FIG. 2 includes and/or identifies at least a portion of a security key, an encryption key, an access key, or some other form of security-based access and/or authentication information. In some examples, the dongle 142 is implemented as a physical security key. In some such examples, connecting the dongle 142 to the controller 132 of the grill 100 of FIG. 1 unlocks (e.g., provides authenticated access to) one or more feature(s) of the controller 132 and/or, more generally, one or more feature(s) of the grill 100.

In some examples, some or all of the grill configuration data 202 of FIG. 2 is utilized to facilitate the registration of the grill 100. For example, the controller 132 of FIG. 1 may evaluate the connection status of the dongle 142 relative to the controller 132 each time the controller 132 is powered on, each time the controller 132 implements (e.g., executes) a boot up cycle, and/or each time the controller 132 implements (e.g., executes) a registration process. In response to the detection circuitry 136 of the controller 132 of FIG. 1 detecting and/or determining that the plug 146 of the dongle 142 is connected (e.g., mechanically and/or electrically connected) to the socket 138 of the controller 132, the control circuitry 134 of the controller 132 may cause some or all of the grill configuration data 202 of FIG. 2 (e.g., the burner configuration data 204, the valve configuration data 206, the fuel source configuration data 208, the ignitor configuration data 210, the cooking surface configuration data 212, the table configuration data 214, the lighting module configuration data 216, the temperature sensor configuration data 218, the flame sensor configuration data 220, the lid position sensor configuration data 222, the fuel level sensor configuration data 224, the product manufacturing data 226, the product identification data 228, and/or the security data 230) stored in and/or on the memory 144 of the dongle 142 to be read by the controller 132. The control circuitry 134 of the controller 132 may additionally cause some or all of the grill configuration data 202 of FIG. 2 read from the memory 144 of the dongle 142 to be stored in and/or on the main memory 140 of the grill 100 of FIG. 1, and/or to be shared with, accessed by, or otherwise made available to the user interface 122 of the grill 100 of FIG. 1.

In some examples, the controller 132 determines whether the grill 100 of FIG. 1 is to implement a registration process. For example, the detection circuitry 136 of the controller 132 may detect and/or determine that the grill 100 is to implement (e.g., execute) a registration process based on one or more user input(s) received via one or more of the input device(s) 124 of the user interface 122 of the grill 100 of FIG. 1, and/or based on one or more user input(s) made at one or more of the remote device(s) 148 of FIG. 1 and received at the grill 100 via one or more of the communication device(s) 130 of the network interface 128 of FIG. 1. As another example, the detection circuitry 136 of the controller 132 may detect and/or determine that the grill 100 is to implement (e.g., execute) a registration process based on the controller 132 implementing (e.g., executing) a boot up cycle. In response to the detection circuitry 136 of the controller 132 detecting and/or determining that the grill 100 is to implement a registration process, the control circuitry 134 of the controller 132 instructs, commands, signals, and/or otherwise causes the network interface 128 of the grill 100 of FIG. 1 to transmit (e.g., via one or more of the communication device(s) 130 of the network interface 128) some or all of the grill configuration data 202 of FIG. 2 read from the memory 144 of the dongle 142 to one or more of the remote device(s) 148 of FIG. 1 to facilitate registration of the grill 100 via the one or more remote device(s) 148.

In some examples, some or all of the grill configuration data 202 of FIG. 2 is utilized to facilitate the identification of one or more configuration-specific cook program(s) to be implemented (e.g., executed) by and/or at the grill 100. For example, the controller 132 of FIG. 1 may evaluate the connection status of the dongle 142 relative to the controller 132 each time the controller 132 is powered on, each time the controller 132 implements (e.g., executes) a boot up cycle, and/or each time the controller 132 implements (e.g., executes) a cook program. In response to the detection circuitry 136 of the controller 132 of FIG. 1 detecting and/or determining that the plug 146 of the dongle 142 is connected (e.g., mechanically and/or electrically connected) to the socket 138 of the controller 132, the control circuitry 134 of the controller 132 may cause some or all of the grill configuration data 202 of FIG. 2 (e.g., the burner configuration data 204, the valve configuration data 206, the fuel source configuration data 208, the ignitor configuration data 210, the cooking surface configuration data 212, the table configuration data 214, the lighting module configuration data 216, the temperature sensor configuration data 218, the flame sensor configuration data 220, the lid position sensor configuration data 222, the fuel level sensor configuration data 224, the product manufacturing data 226, the product identification data 228, and/or the security data 230) stored in and/or on the memory 144 of the dongle 142 to be read by the controller 132. The control circuitry 134 of the controller 132 may additionally cause some or all of the grill configuration data 202 of FIG. 2 read from the memory 144 of the dongle 142 to be stored in and/or on the main memory 140 of the grill 100 of FIG. 1, and/or to be shared with, accessed by, or otherwise made available to the user interface 122 of the grill 100 of FIG. 1.

In some examples, the controller 132 determines whether the grill 100 of FIG. 1 is to implement one or more cook program(s). For example, the detection circuitry 136 of the controller 132 may detect and/or determine that the grill 100 is to implement (e.g., execute) one or more cook program(s) based on one or more user input(s) received via one or more of the input device(s) 124 of the user interface 122 of the grill 100 of FIG. 1, and/or based on one or more user input(s) made at one or more of the remote device(s) 148 of FIG. 1 and received at the grill 100 via one or more of the communication device(s) 130 of the network interface 128 of FIG. 1. In response to the detection circuitry 136 of the controller 132 detecting and/or determining that the grill 100 is to implement one or more cook program(s), the control circuitry 134 of the controller 132 instructs, commands, signals, and/or otherwise causes the network interface 128 of the grill 100 of FIG. 1 to transmit (e.g., via one or more of the communication device(s) 130 of the network interface 128) some or all of the grill configuration data 202 of FIG. 2 read from the memory 144 of the dongle 142 to one or more of the remote device(s) 148 of FIG. 1 to facilitate the identification of one or more configuration-specific cook program(s) by the remote device(s) 148.

The network interface 128 of FIG. 1 thereafter receives (e.g., via one or more of the communication device(s) 130 of the network interface 128) configuration-specific cook program data from one or more of the remote device(s) 148 of FIG. 1, with the received configuration-specific cook program data being specifically tailored to some or all of the grill configuration data 202 of FIG. 2. The control circuitry 134 of the controller 132 may cause some or all of the configuration-specific cook program data received from the one or more remote device(s) 148 to be stored in and/or on the main memory 140 of the grill 100 of FIG. 1, and/or to be shared with, accessed by, or otherwise made available to the user interface 122 of the grill 100 of FIG. 1. The control circuitry 134 of the controller 132 instructs, commands, signals, and/or otherwise causes the user interface 122 and/or one or more other controllable component(s) of the grill 100 to implement (e.g., execute) one or more configuration-specific cook program(s) based on the configuration-specific cook program data, with the implemented configuration-specific cook program(s) being specifically tailored to some or all of the grill configuration data 202 of FIG. 2.

In some examples, the security data 230 of the grill configuration data 202 of FIG. 2 is utilized to unlock (e.g., provide authenticated access to) one or more feature(s) of the controller 132 and/or, more generally, one or more feature(s) of the grill 100 of FIG. 1 pursuant to an authentication process of the grill 100. For example, the controller 132 of FIG. 1 may evaluate the connection status of the dongle 142 relative to the controller 132 each time the controller 132 is powered on, each time the controller 132 implements (e.g., executes) a boot up cycle, and/or each time the controller 132 implements (e.g., executes) an authentication process. In response to the detection circuitry 136 of the controller 132 of FIG. 1 detecting and/or determining that the plug 146 of the dongle 142 is connected (e.g., mechanically and/or electrically connected) to the socket 138 of the controller 132, the control circuitry 134 of the controller 132 may cause some or all of the security data 230 stored in and/or on the memory 144 of the dongle 142 to be read by the controller 132. The control circuitry 134 of the controller 132 may additionally cause some or all of the security data 230 of FIG. 2 read from the memory 144 of the dongle 142 to be stored in and/or on the main memory 140 of the grill 100 of FIG. 1, and/or to be shared with, accessed by, or otherwise made available to the user interface 122 of the grill 100 of FIG. 1.

In some examples, the controller 132 implements an authentication process for which the security data 230 stored in and/or on the memory 144 of the dongle 142 is a necessary component. In this regard, the dongle 142 may be implemented as a physical security key, and the security data 230 stored in and/or on the dongle 142 may include and/or identify at least a portion of a security key, an encryption key, an access key, or some other form of security-based access and/or authentication information. In some such examples, connecting the dongle 142 to the controller 132 enables the controller 132 to complete an authentication process that is dependent upon the controller 132 successfully reading and/or otherwise obtaining the specific security data 230 that is stored in and/or on the memory 144 of the dongle 142. Successfully completing the authentication process may in turn unlock one or more feature(s) of the controller 132 and/or, more generally, one or more feature(s) of the grill 100.

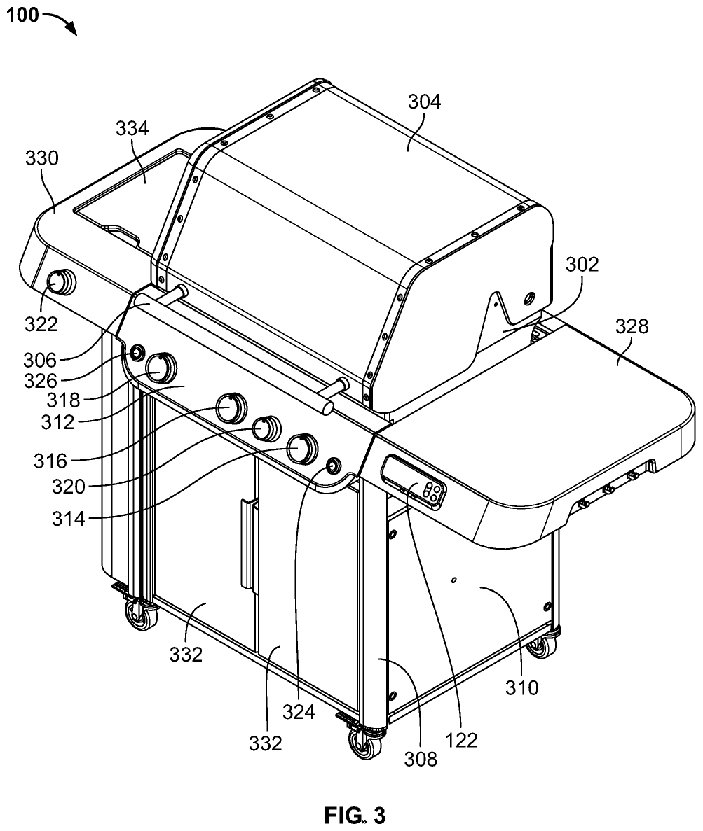

FIG. 3 is a perspective view of an example implementation of the grill 100 of FIG. 1. As shown in FIG. 3, the grill 100 includes an example cookbox 302, an example lid 304, an example handle 306, an example frame 308, an example cabinet 310, an example control panel 312, an example first control knob 314, an example second control knob 316, an example third control knob 318, an example fourth control knob 320, an example fifth control knob 322, an example first control button 324, an example second control button 326, an example first side table 328, and an example second side table 330. As further shown in FIG. 3, the cabinet 310 includes example doors 332, the first side table 328 includes the user interface 122, and the second side table 330 includes an example side burner cover 334.

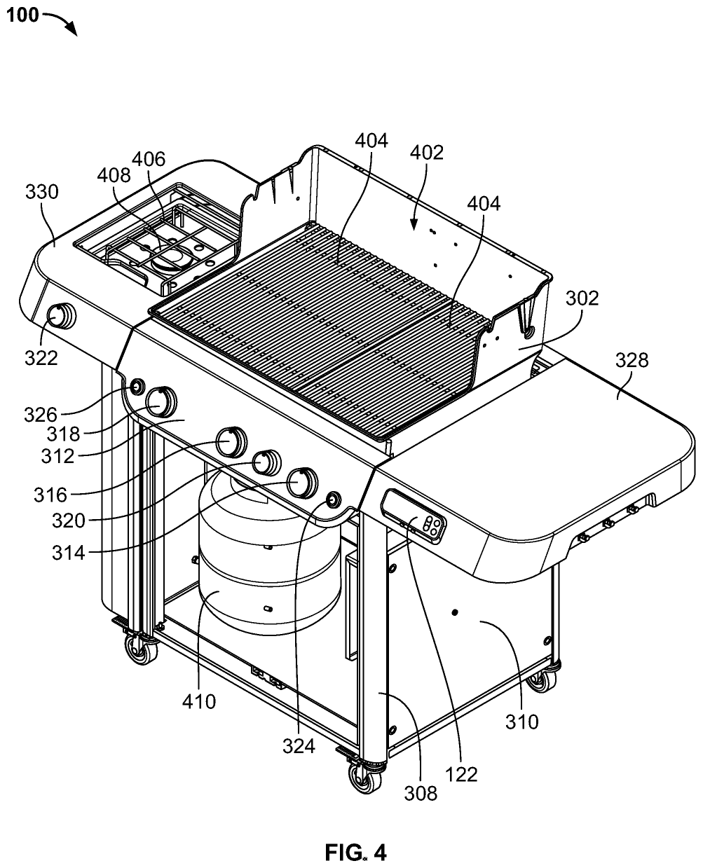

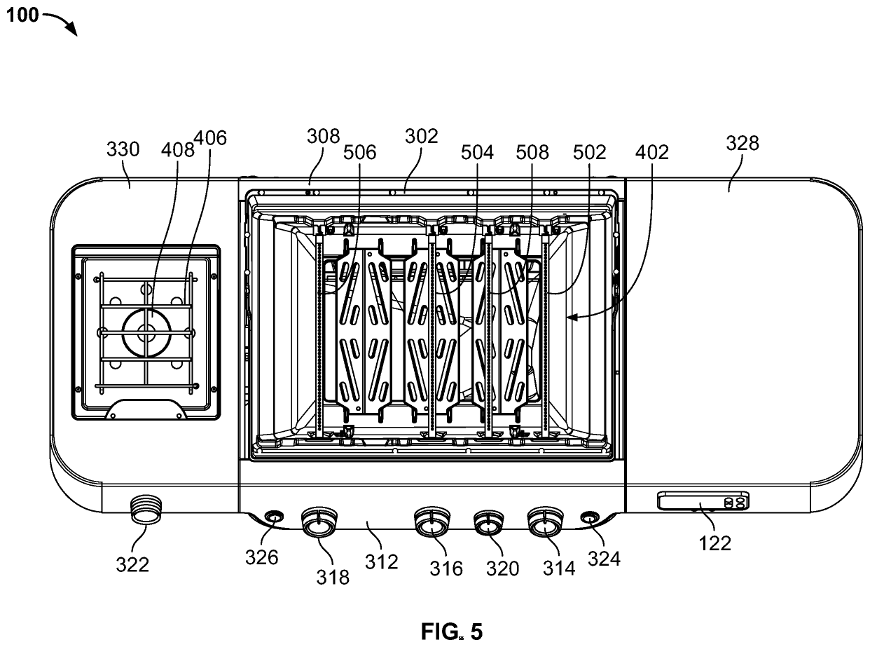

FIG. 4 is a perspective view of the implementation of the grill 100 shown in FIG. 3, with the lid 304 of the grill 100, the side burner cover 334 of the second side table 330, and the doors 332 of the cabinet 310 removed. As shown in FIG. 4, the grill 100 includes an example cooking chamber 402 defined in part by the cookbox 302. As further shown in FIG. 4, the cookbox 302 includes example grilling grates 404 seated over one or more burner(s), the second side table 330 includes an example burner grate 406 seated over an example side burner 408, and the cabinet 310 includes an example fuel tank 410 located beneath the cookbox 302. FIG. 5 is a top view of the implementation of the grill 100 shown in FIGS. 3 and 4, with the lid 304 of the grill 100, the side burner cover 334 of the second side table 330, the doors 332 of the cabinet 310, and the grilling grates 404 of the cookbox 302 removed. As shown in FIG. 5, the grill 100 includes an example first main burner 502, an example second main burner 504, an example third main burner 506, and an example sear burner 508 respectively located within the cookbox 302 of the grill 100.

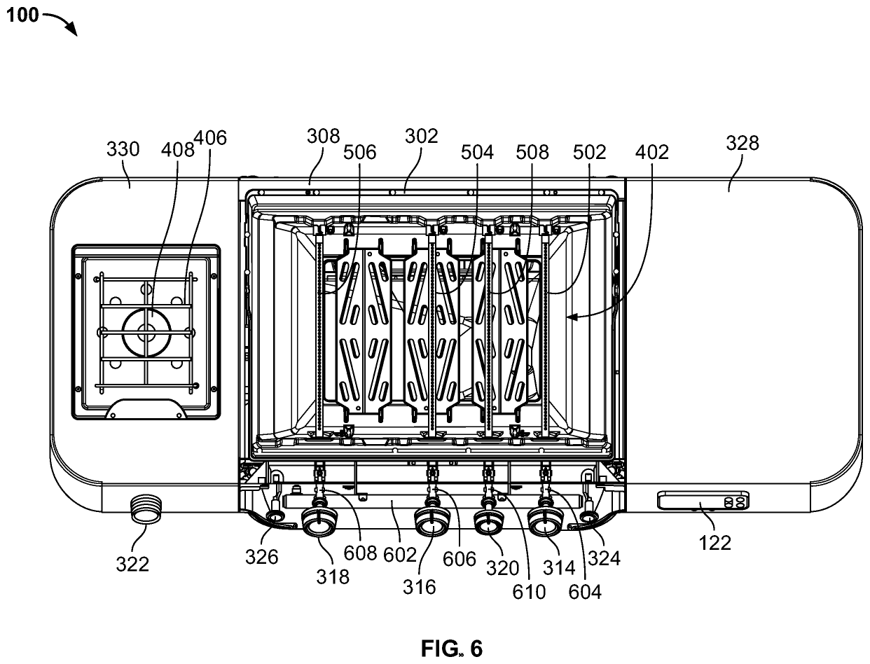

FIG. 6 is a top view of the implementation of the grill 100 shown in FIGS. 3-5, with the lid 304 of the grill 100, the side burner cover 334 of the second side table 330, the doors 332 of the cabinet 310, the grilling grates 404 of the cookbox 302, and the control panel 312 of the grill 100 removed. As shown in FIG. 6, the grill 100 includes an example manifold 602, an example first valve 604 operatively positioned between the manifold 602 and the first main burner 502, an example second valve 606 operatively positioned between the manifold 602 and the second main burner 504, an example third valve 608 operatively positioned between the manifold 602 and the third main burner 506, and an example fourth valve 610 operatively positioned between the manifold 602 and the sear burner 508. Although not visible in FIG. 6, the grill 100 additionally includes a fifth valve operatively positioned between the manifold 602 and the side burner 408 of the grill 100. As further shown in FIG. 6, the first control knob 314 is operatively coupled to the first valve 604 to facilitate control over a flow of gas entering the first main burner 502, the second control knob 316 is operatively coupled to the second valve 606 to facilitate control over a flow of gas entering the second main burner 504, the third control knob 318 is operatively coupled to the third valve 608 to facilitate control over a flow of gas entering the third main burner 506, the fourth control knob 320 is operatively coupled to the fourth valve 610 to facilitate control over a flow of gas entering the sear burner 508, and the fifth control knob 322 is operatively coupled to the fifth valve to facilitate control over a flow of gas entering the side burner 408.

In the illustrated example of FIGS. 3-6, the lid 304 of the grill 100 covers and/or encloses the cookbox 302 of the grill 100 when the lid 304 is in a closed position (e.g., as shown in FIG. 3). The lid 304 is movably (e.g., pivotally) coupled to the cookbox 302 such that the lid 304 can be moved (e.g., pivoted) relative to the cookbox 302 between a closed position and an open position. Movement of the lid 304 between the closed position and the open position can be facilitated via user interaction with the handle 306 that is coupled to the lid 304. The cookbox 302 and the lid 304 of the grill 100 collectively define the cooking chamber 402 of the grill 100, which is configured to cook one or more item(s) of food. The cooking chamber 402 becomes accessible to a user of the grill 100 when the lid 304 is in the open position. Conversely, the cooking chamber 402 is generally inaccessible to the user of the grill 100 when the lid 304 is in the closed position. User access to the cooking chamber 402 of the grill 100 may periodically become necessary, for example, to add an item of food to the cooking chamber 402 (e.g., at or toward the beginning of a cook program), to remove an item of food from the cooking chamber 402 (e.g., at or toward the end of a cook program), and/or to flip, rotate, relocate, or otherwise move an item of food within the cooking chamber 402 (e.g., during the middle of a cook program).

In the illustrated example of FIGS. 3-6, the frame 308 of the grill 100 supports the cookbox 302 of the grill 100, and also defines the cabinet 310 of the grill 100. Opening the doors 332 of the cabinet 310 enables a user to access an interior of the cabinet 310 to interact with one or more component(s) of the grill 100 located therein. The cookbox 302 and/or the frame 308 of the grill 100 support(s) the control panel 312 of the grill 100, which is located along a front portion of the cookbox 302 and/or along a front portion of the frame 308. The first control knob 314, the second control knob 316, the third control knob 318, the fourth control knob 320, the first control button 324, and the second control button 326 are respectively carried by, mounted to, and/or otherwise located along the control panel 312. In the illustrated example of FIGS. 3-6, the first control button 324 is operatively coupled to a lighting module (e.g., a knob lighting module) of the grill 100, and the second control button 326 is operatively coupled to an ignitor of the grill 100. User interaction with the first control button 324 causes the lighting module to transition between from an off state (e.g., a non-light projecting state) to an on state (e.g., a light projecting state), and vice-versa. User interaction with the second control button 326 causes the ignitor to generate sparks with the intent of igniting gas flowing into one or more of the first main burner 502, the second main burner 504, the third main burner 506, the sear burner 508, and/or the side burner 408 of the grill 100.

The cookbox 302 and/or the frame 308 of the grill 100 also support(s) the first side table 328 and the second side table 330 of the grill 100. In the illustrated example of FIGS. 3-6, the first side table 328 is located along a right side of the cookbox 302 and/or along a right side of the frame 308, and the second side table 330 is located along a left side of the cookbox 302 and/or along a left side of the frame 308. The user interface 122 is mounted to a front portion (e.g., a front panel) of the first side table 328. The side burner cover 334, the burner grate 406, and the side burner 408 are located along and/or are accessible via a top portion (e.g., a top panel) of the second side table 330. The fifth control knob 322 is carried by, mounted to, and/or otherwise located along a front portion (e.g., a front panel) of the second side table 330.

In the illustrated example of FIGS. 3-6, the first main burner 502, the second main burner 504, the third main burner 506, the sear burner 508, and/or the side burner 408 is/are included among the burner(s) 102 of the grill 100. Data and/or information pertaining to the first main burner 502, the second main burner 504, the third main burner 506, the sear burner 508, and/or the side burner 408 is accordingly included within the burner configuration data 204 stored in and/or on the memory 144 of the dongle 142 of FIG. 1. The first valve 604, the second valve 606, the third valve 608, the fourth valve 610, and/or the fifth valve is/are included among the valve(s) 104 of the grill 100. Data and/or information pertaining to the first valve 604, the second valve 606, the third valve 608, the fourth valve 610, and/or the fifth valve is accordingly included within the valve configuration data 206 stored in and/or on the memory 144 of the dongle 142 of FIG. 1. The fuel tank 410 corresponds to the fuel source 106 of the grill 100. Data and/or information pertaining to the fuel tank 410 is accordingly included within the fuel source configuration data 208 stored in and/or on the memory 144 of the dongle 142 of FIG. 1. The ignitor operatively coupled to the second control button 326 is included among the ignitor(s) 108 of the grill 100. Data and/or information pertaining to ignitor operatively coupled to the second control button 326 is accordingly included within the ignitor configuration data 210 stored in and/or on the memory 144 of the dongle 142 of FIG. 1. The grilling grates 404 and/or the burner grate 406 is/are included among the cooking surface(s) 110 of the grill 100. Data and/or information pertaining to the grilling grates 404 and/or the burner grate 406 is accordingly included within the cooking surface configuration data 212 stored in and/or on the memory 144 of the dongle 142 of FIG. 1. The first side table 328 and/or the second side table 330 is/are included among the table(s) of the grill 100. Data and/or information pertaining to the first side table 328 and/or the second side table 330 is accordingly included within the table configuration data 214 stored in and/or on the memory 144 of the dongle 142 of FIG. 1. The lighting module operatively coupled to the first control button 324 is included among the lighting module(s) 112 of the grill 100. Data and/or information pertaining to the lighting module operatively coupled to the first control button 324 is accordingly included within the lighting module configuration data 216 stored in and/or on the memory 144 of the dongle 142 of FIG. 1.

In some examples, the grill 100 as shown in FIGS. 3-6 further includes one or more temperature sensor(s), one or more flame sensor(s), one or more lid position sensor(s), and/or one or more fuel level sensor(s). In such examples, data and/or information pertaining to the included temperature sensor(s), the included flame sensor(s), the included lid position sensor(s), and/or the included fuel level sensor(s) is included within corresponding ones of the temperature sensor configuration data 218, the flame sensor configuration data 220, the lid position sensor configuration data 222, and/or the fuel level sensor configuration data 224 stored in and/or on the memory 144 of the dongle 142 of FIG. 1. In some examples, the grill 100 as shown in FIGS. 3-6 further includes associated product manufacturing data, associated product identification data, and/or associated security data. In such examples, data and/or information pertaining to the product manufacturing data, the product identification data, and/or the security data is included within corresponding ones of the product manufacturing data 226, the product identification data 228, and the security data 230 stored in and/or on the memory 144 of the dongle 142 of FIG. 1.

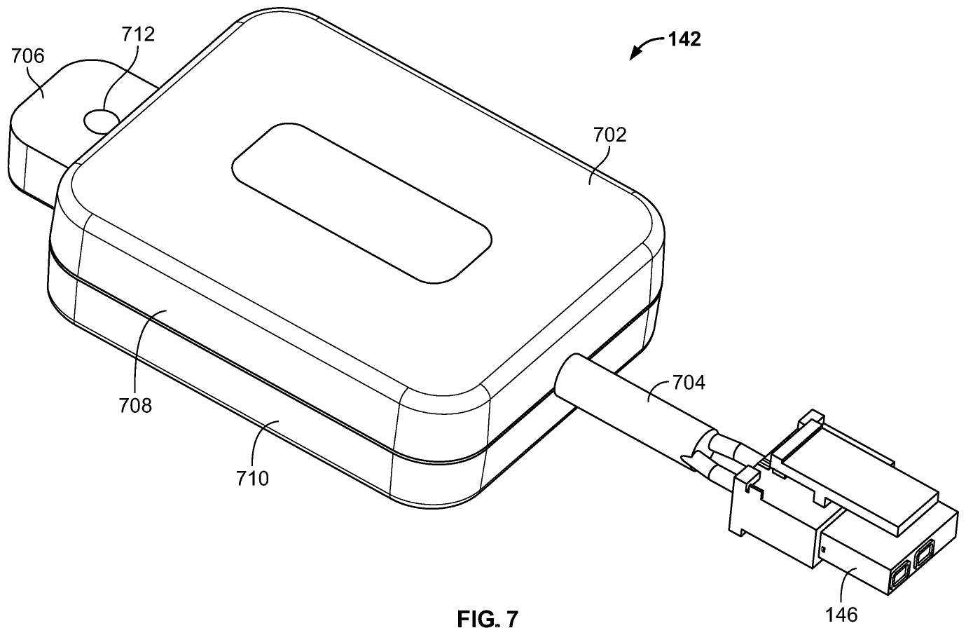

FIG. 7 is perspective view of an example implementation of the dongle 142 of FIGS. 1 and 2. As shown in FIG. 7, the dongle 142 includes the memory 144, the plug 146, an example housing 702, an example cable 704, and an example mounting flange 706. In the illustrated example of FIG. 7, the housing 702 of the dongle 142 is configured as a clamshell-style housing having an example first portion 708 (e.g., a cover) and an example second portion 710 (e.g., a base), with the first portion 708 being removably couplable to the second portion 710 to enable a user to access one or more component(s) of the dongle 142 located within the housing 702. For example, in the implementation shown in FIG. 7, the memory 144 of the dongle 142 is located within the housing 702 of the dongle 142, with the memory 144 becoming physically accessible when the first portion 708 of the housing 702 is removed from the second portion 710 of the housing 702. The cable 704 of the dongle 142 includes one or more wire(s) that operatively couple(s) the memory 144 of the dongle 142 to the plug 146 of the dongle 142. Data and or information (e.g., the grill configuration data 202 of FIG. 2) stored in and/or on the memory 144 of the dongle 142 can be transferred via the cable 704 and the plug 146 of the dongle 142 to the controller 132 of the grill 100 when the plug 146 of the dongle 142 is connected to the socket 138 of the controller 132.

In the illustrated example of FIG. 7, the mounting flange 706 of the dongle 142 is coupled to and/or extends from the second portion 710 of the housing 702 of the dongle 142. The mounting flange 706 includes an example opening 712 (e.g., a through hole) configured to receive a fastener, with the fastener being configured to securely couple the mounting flange 706 and/or, more generally, the second portion 710 of the housing 702 to a structural component (e.g., a frame, a cabinet, a control panel, a side table, etc.) of the grill 100. The housing 702 of the dongle 142 is advantageously configured such that the first portion 708 of the housing 702 can be freely removed from the second portion 710 of the housing 702 while the second portion 710 of the housing remains securely coupled to the structural component of the grill 100. One or more component(s) located within the housing 702 can accordingly be accessed without removing the entire housing 702, and/or without removing the dongle 142 from the structural component of the grill 100 to which the second portion 710 of the housing 702 of the dongle 142 is securely coupled.

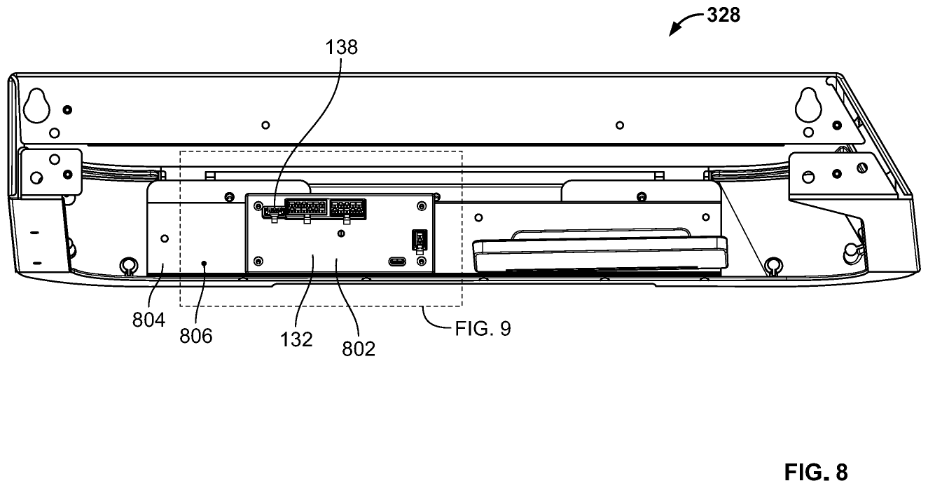

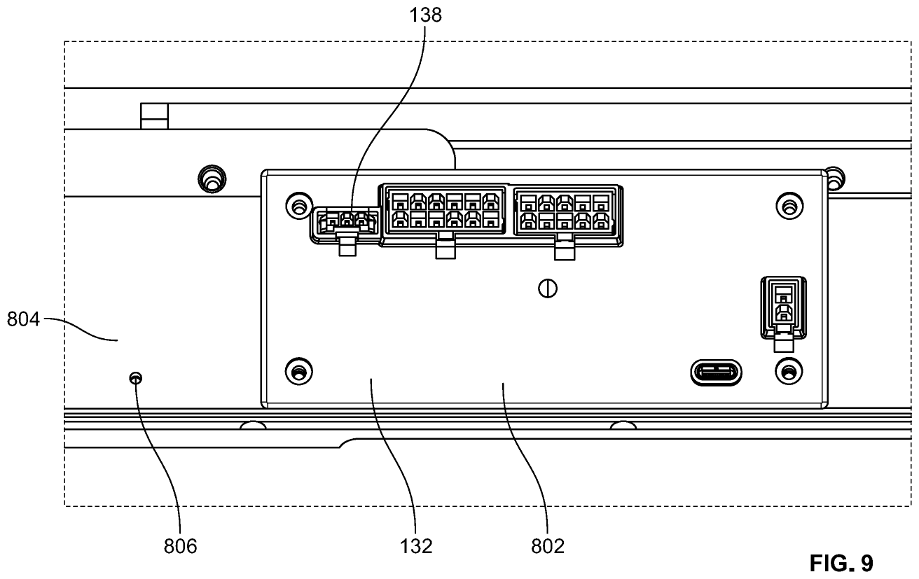

FIG. 8 is a bottom-side perspective view of the first side table 328 of the implementation of the grill 100 of FIG. 1 as shown in FIGS. 3-6. FIG. 9 is an enlarged view of a portion of FIG. 8. As shown in FIGS. 8 and 9, the controller 132 of the grill 100 includes an example housing 802. The housing 802 of the controller 132 is configured to support one or more component(s) of the controller 132 including, for example, the control circuitry 134, the detection circuitry 136, and/or the socket 138 of the controller 132. In the illustrated example of FIGS. 8 and 9, the housing 802 of the controller 132 is coupled to an example sidewall 804 of the first side table 328 via one or more fastener(s) (e.g., one or more screw(s), bolt(s), rivet(s), etc.). The sidewall 804 of the first side table 328 includes an example opening 806 (e.g., a through hole) configured to receive a fastener to couple the mounting flange 706 of the dongle 142 to the sidewall 804 of the first side table 328.

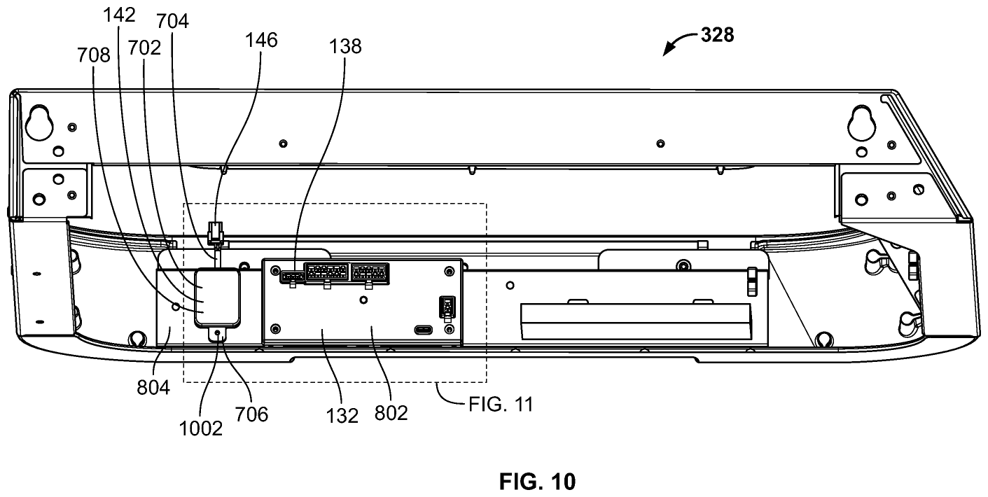

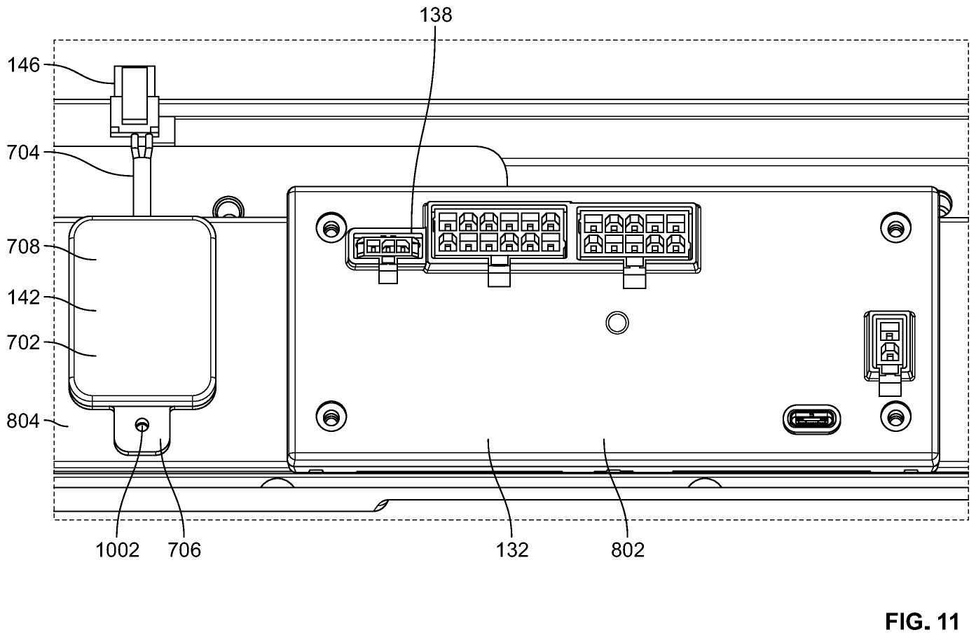

FIG. 10 is a bottom-side perspective view of the first side table 328 of the implementation of the grill 100 of FIG. 1 as shown in FIGS. 3-6, 8, and 9, with the implementation of the dongle 142 of FIGS. 1 and 2 as shown in FIG. 7 mounted to the first side table 328, and with the dongle 142 disconnected from the controller 132. FIG. 11 is an enlarged view of a portion of FIG. 10. In the illustrated example of FIGS. 10 and 11, the dongle 142 is securely coupled to the sidewall 804 of the first side table 328 via an example fastener 1002 (e.g., a screw, a bolt, a rivet, etc.) that passes through the opening 712 of the mounting flange 706 of the dongle 142, and through and/or into the opening 806 of the sidewall 804 of the first side table 328. As shown in FIGS. 10 and 11, the plug 146 of the dongle 142 is not physically connected to the socket 138 of the controller 132. The controller 132 is accordingly unable to read and/or otherwise access any grill configuration data (e.g., the grill configuration data 202 of FIG. 2) that may be stored in and/or on the memory 144 of the dongle 142.

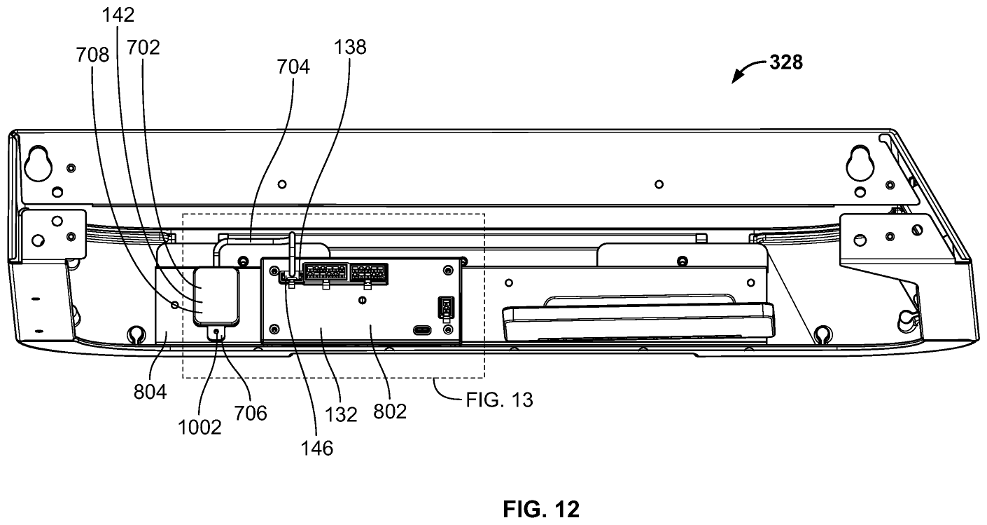

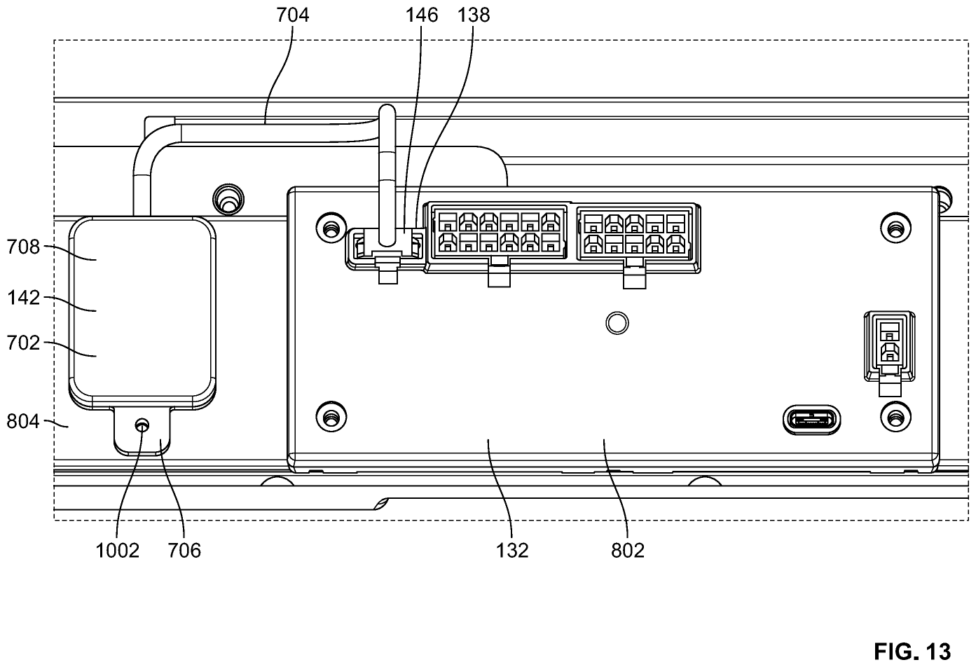

FIG. 12 is a bottom-side perspective view of the first side table 328 of the implementation of the grill 100 of FIG. 1 as shown in FIGS. 3-6 and 8-11, with the implementation of the dongle 142 of FIGS. 1 and 2 as shown in FIGS. 7, 10, and 11 mounted to the first side table 328, and with the dongle 142 connected to the controller 132. FIG. 13 is an enlarged view of a portion of FIG. 12. In the illustrated example of FIGS. 12 and 13, the dongle 142 remains securely coupled to the sidewall 804 of the first side table 328 via the fastener 1002. As shown in FIGS. 12 and 13, the plug 146 of the dongle 142 is physically connected to the socket 138 of the controller 132. The controller 132 is accordingly able to read and/or access any grill configuration data (e.g., the grill configuration data 202 of FIG. 2) that may be stored in and/or on the memory 144 of the dongle 142.

While example manners of implementing the grill 100 are illustrated in FIGS. 1-13, one or more of the elements, processes, and/or devices illustrated in FIGS. 1-13 may be combined, divided, re-arranged, omitted, eliminated, and/or implemented in any other way. Further, the example valve(s) 104, the example ignitor(s) 108, the example lighting module(s) 112, the example temperature sensor(s) 114, the example flame sensor(s) 116, the example lid position sensor(s) 118, the example fuel level sensor(s) 120, the example user interface 122 (e.g., including the example input device(s) 124 and the example output device(s) 126), the example network interface 128 (e.g., including the example communication device(s) 130), the example controller 132 (e.g., including the example control circuitry 134, the example detection circuitry 136, and the example socket 138), the example main memory 140, the example dongle 142 (e.g., including the example memory 144 and the example plug 146) and/or, more generally, the control system of the grill 100 of FIGS. 1-13, may be implemented by hardware alone or by hardware in combination with software and/or firmware. Thus, for example, any of the example valve(s) 104, the example ignitor(s) 108, the example lighting module(s) 112, the example temperature sensor(s) 114, the example flame sensor(s) 116, the example lid position sensor(s) 118, the example fuel level sensor(s) 120, the example user interface 122 (e.g., including the example input device(s) 124 and the example output device(s) 126), the example network interface 128 (e.g., including the example communication device(s) 130), the example controller 132 (e.g., including the example control circuitry 134, the example detection circuitry 136, and the example socket 138), the example main memory 140, the example dongle 142 (e.g., including the example memory 144 and the example plug 146) and/or, more generally, the control system of the grill 100 of FIGS. 1-13, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example control system of the grill of FIGS. 1-13 may include one or more elements, processes, and/or devices in addition to, or instead of, those illustrated in FIGS. 1-13, and/or may include more than one of any or all of the illustrated elements, processes, and devices.

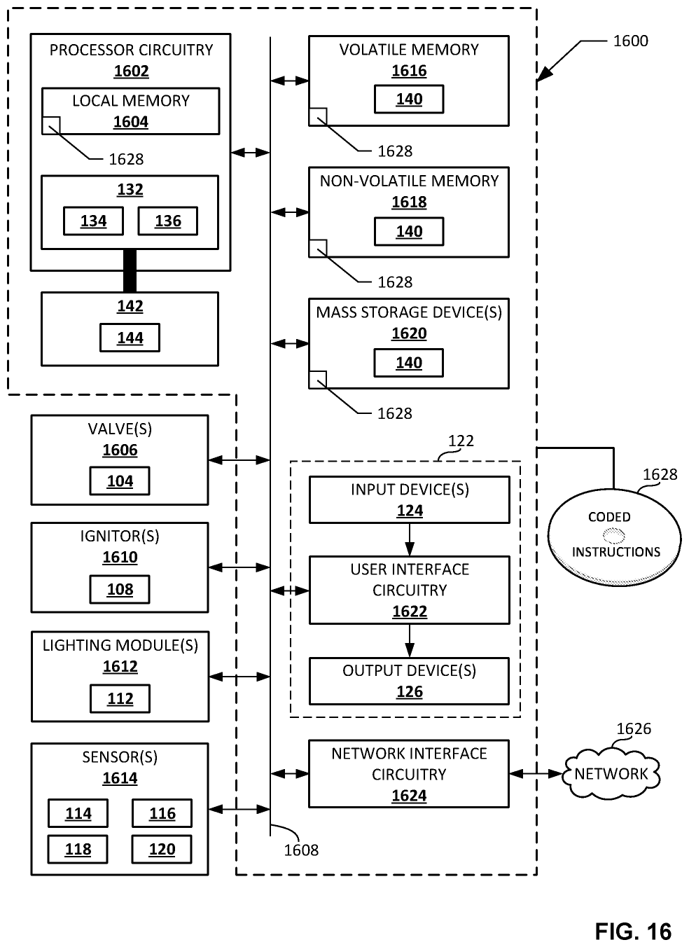

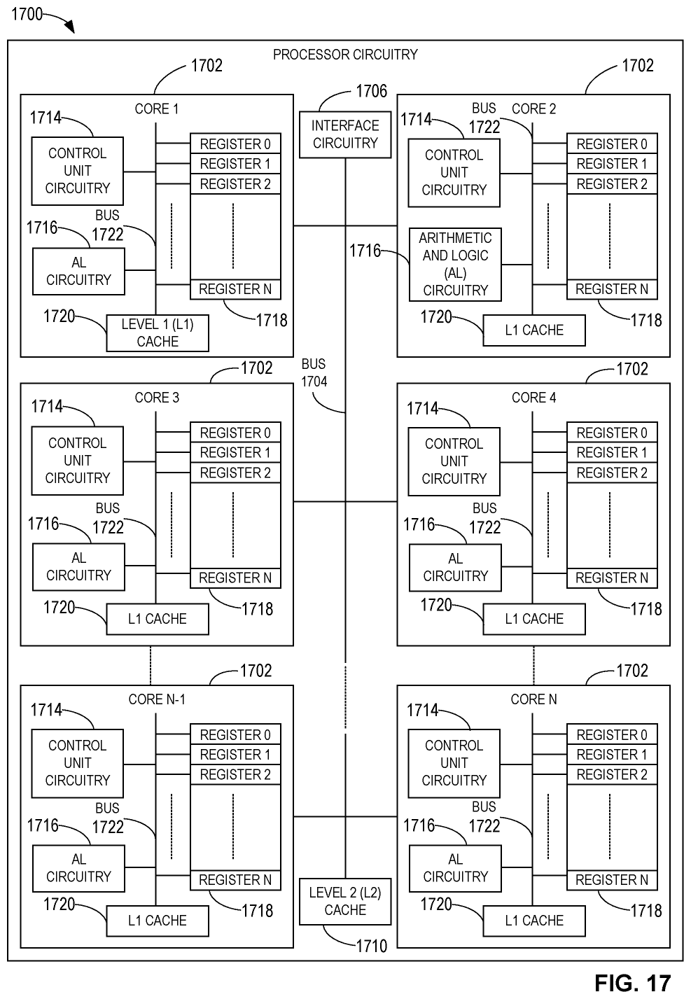

Flowcharts representative of example hardware logic circuitry, machine-readable instructions, hardware implemented state machines, and/or any combination thereof for implementing the grill 100 of FIGS. 1-13 are shown in FIGS. 14 and 15. The machine-readable instructions may be one or more executable programs or portion(s) of an executable program for execution by processor circuitry, such as the processor circuitry 1602 shown in the example processor platform 1600 discussed below in connection with FIG. 16 and/or the example processor circuitry discussed below in connection with FIGS. 17 and/or 18. The programs may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire programs and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although example programs are described with reference to the flowcharts illustrated in FIGS. 14 and 15, many other methods of implementing the example grill 100 may alternatively be used. For example, the order of execution of the blocks may be changed, and/or some of the blocks described may be changed, eliminated, or combined. Additionally, or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine-executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or any other machine. For example, the machine-readable instructions may be stored in multiple parts, which are individually compressed, encrypted, and/or stored on separate computing devices, wherein the parts when decrypted, decompressed, and/or combined form a set of machine-executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or any other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 14 and 15 may be implemented using executable instructions (e.g., computer and/or machine-readable instructions) stored on one or more non-transitory computer and/or machine-readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable medium” and “non-transitory computer-readable storage medium” are expressly defined to include any type of computer-readable storage device and/or storage disk and to exclude propagating signals and to exclude transmission media.

The terms “including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

FIG. 14 is a flowchart representative of example machine-readable instructions and/or example operations 1400 that may be executed by processor circuitry to implement the grill 100 of FIG. 1. The machine-readable instructions and/or operations 1400 of FIG. 14 begin at block 1402 when the controller 132 of FIG. 1 determines whether the dongle 142 of FIG. 1 is connected to the controller 132. For example, the detection circuitry 136 of the controller 132 may detect and/or determine that the plug 146 of the dongle 142 is connected (e.g., mechanically and/or electrically connected) to the socket 138 of the controller 132. In some examples, the controller 132 evaluates the connection status of the dongle 142 relative to the controller 132 each time the controller 132 is powered on, each time the controller 132 implements (e.g., executes) a boot up cycle, and/or each time the controller 132 implements (e.g., executes) a registration process. If the controller 132 determines at block 1402 that the dongle 142 is not connected to the controller 132, control of the machine-readable instructions and/or operations 1400 of FIG. 14 remains at block 1402. If the controller 132 instead determines at block 1402 that the dongle 142 is connected to the controller 132, control of the machine-readable instructions and/or operations 1400 of FIG. 14 proceeds to block 1404.

At block 1404, the controller 132 reads configuration data stored in and/or on the memory 144 of the dongle 142. For example, the control circuitry 134 of the controller 132 may cause some or all of the grill configuration data 202 of FIG. 2 (e.g., the burner configuration data 204, the valve configuration data 206, the fuel source configuration data 208, the ignitor configuration data 210, the cooking surface configuration data 212, the table configuration data 214, the lighting module configuration data 216, the temperature sensor configuration data 218, the flame sensor configuration data 220, the lid position sensor configuration data 222, the fuel level sensor configuration data 224, the product manufacturing data 226, the product identification data 228, and/or the security data 230) stored in and/or on the memory 144 of the dongle 142 to be read by the controller 132. Following block 1404, control of the example machine-readable instructions and/or operations 1400 of FIG. 14 proceeds to block 1406.

At block 1406, the controller 132 processes the configuration data read from the memory 144 of the dongle 142. For example, the control circuitry 134 of the controller 132 may cause some or all of the grill configuration data 202 of FIG. 2 (e.g., the burner configuration data 204, the valve configuration data 206, the fuel source configuration data 208, the ignitor configuration data 210, the cooking surface configuration data 212, the table configuration data 214, the lighting module configuration data 216, the temperature sensor configuration data 218, the flame sensor configuration data 220, the lid position sensor configuration data 222, the fuel level sensor configuration data 224, the product manufacturing data 226, the product identification data 228, and/or the security data 230) read from the memory 144 of the dongle 142 to be stored in and/or on the main memory 140 of the grill 100 of FIG. 1, and/or to be shared with, accessed by, or otherwise made available to the user interface 122 of the grill 100 of FIG. 1. Following block 1406, control of the example machine-readable instructions and/or operations 1400 of FIG. 14 proceeds to block 1408.

At block 1408, the controller 132 determines whether the grill 100 of FIG. 1 is to implement a registration process. For example, the detection circuitry 136 of the controller 132 may detect and/or determine that the grill 100 is to implement (e.g., execute) a registration process based on one or more user input(s) received via one or more of the input device(s) 124 of the user interface 122 of the grill 100 of FIG. 1, and/or based on one or more user input(s) made at one or more of the remote device(s) 148 of FIG. 1 and received at the grill 100 via one or more of the communication device(s) 130 of the network interface 128 of FIG. 1. As another example, the detection circuitry 136 of the controller 132 may detect and/or determine that the grill 100 is to implement (e.g., execute) a registration process based on the controller 132 implementing (e.g., executing) a boot up cycle. If the controller 132 determines at block 1408 that the grill 100 is not to implement a registration process, control of the machine-readable instructions and/or operations 1400 of FIG. 14 remains at block 1408. If the controller 132 instead determines at block 1408 that the grill 100 is to implement a registration process, control of the machine-readable instructions and/or operations 1400 of FIG. 14 proceeds to block 1410.

At block 1410, the controller 132 instructs, commands, signals, and/or otherwise causes the configuration data read from the memory 144 of the dongle 142 to be transmitted to one or more of the remote device(s) 148 of FIG. 1 to facilitate registration of the grill 100 via the one or more remote device(s) 148. For example, the control circuitry 134 of the controller 132 may instruct, command, signal, and/or otherwise cause the network interface 128 of the grill 100 of FIG. 1 to transmit (e.g., via one or more of the communication device(s) 130 of the network interface 128) some or all of the grill configuration data 202 of FIG. 2 (e.g., the burner configuration data 204, the valve configuration data 206, the fuel source configuration data 208, the ignitor configuration data 210, the cooking surface configuration data 212, the table configuration data 214, the lighting module configuration data 216, the temperature sensor configuration data 218, the flame sensor configuration data 220, the lid position sensor configuration data 222, the fuel level sensor configuration data 224, the product manufacturing data 226, the product identification data 228, and/or the security data 230) read from the memory 144 of the dongle 142 to one or more of the remote device(s) 148 of FIG. 1 to facilitate registration of the grill 100 via the one or more remote device(s) 148. Following block 1410, the machine-readable instructions and/or operations 1400 of FIG. 14 end.

FIG. 15 is a flowchart representative of example machine-readable instructions and/or example operations 1500 that may be executed by processor circuitry to implement the grill 100 of FIG. 1. The machine-readable instructions and/or operations 1500 of FIG. 15 begin at block 1502 when the controller 132 of FIG. 1 determines whether the dongle 142 of FIG. 1 is connected to the controller 132. For example, the detection circuitry 136 of the controller 132 may detect and/or determine that the plug 146 of the dongle 142 is connected (e.g., mechanically and/or electrically connected) to the socket 138 of the controller 132. In some examples, the controller 132 evaluates the connection status of the dongle 142 relative to the controller 132 each time the controller 132 is powered on, each time the controller 132 implements (e.g., executes) a boot up cycle, and/or each time the controller 132 implements (e.g., executes) a cook program. If the controller 132 determines at block 1502 that the dongle 142 is not connected to the controller 132, control of the machine-readable instructions and/or operations 1500 of FIG. 15 remains at block 1402. If the controller 132 instead determines at block 1502 that the dongle 142 is connected to the controller 132, control of the machine-readable instructions and/or operations 1500 of FIG. 15 proceeds to block 1504.

At block 1504, the controller 132 reads configuration data stored in and/or on the memory 144 of the dongle 142. For example, the control circuitry 134 of the controller 132 may cause some or all of the grill configuration data 202 of FIG. 2 (e.g., the burner configuration data 204, the valve configuration data 206, the fuel source configuration data 208, the ignitor configuration data 210, the cooking surface configuration data 212, the table configuration data 214, the lighting module configuration data 216, the temperature sensor configuration data 218, the flame sensor configuration data 220, the lid position sensor configuration data 222, the fuel level sensor configuration data 224, the product manufacturing data 226, the product identification data 228, and/or the security data 230) stored in and/or on the memory 144 of the dongle 142 to be read by the controller 132. Following block 1504, control of the example machine-readable instructions and/or operations 1500 of FIG. 15 proceeds to block 1506.

At block 1506, the controller 132 processes the configuration data read from the memory 144 of the dongle 142. For example, the control circuitry 134 of the controller 132 may cause some or all of the grill configuration data 202 of FIG. 2 (e.g., the burner configuration data 204, the valve configuration data 206, the fuel source configuration data 208, the ignitor configuration data 210, the cooking surface configuration data 212, the table configuration data 214, the lighting module configuration data 216, the temperature sensor configuration data 218, the flame sensor configuration data 220, the lid position sensor configuration data 222, the fuel level sensor configuration data 224, the product manufacturing data 226, the product identification data 228, and/or the security data 230) read from the memory 144 of the dongle 142 to be stored in and/or on the main memory 140 of the grill 100 of FIG. 1, and/or to be shared with, accessed by, or otherwise made available to the user interface 122 of the grill 100 of FIG. 1. Following block 1506, control of the example machine-readable instructions and/or operations 1500 of FIG. 15 proceeds to block 1508.

At block 1508, the controller 132 determines whether the grill 100 of FIG. 1 is to implement one or more cook program(s). For example, the detection circuitry 136 of the controller 132 may detect and/or determine that the grill 100 is to implement (e.g., execute) one or more cook program(s) based on one or more user input(s) received via one or more of the input device(s) 124 of the user interface 122 of the grill 100 of FIG. 1, and/or based on one or more user input(s) made at one or more of the remote device(s) 148 of FIG. 1 and received at the grill 100 via one or more of the communication device(s) 130 of the network interface 128 of FIG. 1. If the controller 132 determines at block 1508 that the grill 100 is not to implement any cook program(s), control of the machine-readable instructions and/or operations 1500 of FIG. 15 remains at block 1508. If the controller 132 instead determines at block 1508 that the grill 100 is to implement one or more cook program(s), control of the machine-readable instructions and/or operations 1500 of FIG. 15 proceeds to block 1510.

At block 1510, the controller 132 instructs, commands, signals, and/or otherwise causes the configuration data read from the memory 144 of the dongle 142 to be transmitted to one or more of the remote device(s) 148 of FIG. 1 to facilitate identification of one or more configuration-specific cook program(s) by the remote device(s) 148. For example, the control circuitry 134 of the controller 132 may instruct, command, signal, and/or otherwise cause the network interface 128 of the grill 100 of FIG. 1 to transmit (e.g., via one or more of the communication device(s) 130 of the network interface 128) some or all of the grill configuration data 202 of FIG. 2 (e.g., the burner configuration data 204, the valve configuration data 206, the fuel source configuration data 208, the ignitor configuration data 210, the cooking surface configuration data 212, the table configuration data 214, the lighting module configuration data 216, the temperature sensor configuration data 218, the flame sensor configuration data 220, the lid position sensor configuration data 222, the fuel level sensor configuration data 224, the product manufacturing data 226, the product identification data 228, and/or the security data 230) read from the memory 144 of the dongle 142 to one or more of the remote device(s) 148 of FIG. 1 to facilitate identification of one or more configuration-specific cook program(s) by the remote device(s) 148. Following block 1510, control of the machine-readable instructions and/or operations 1500 of FIG. 15 proceeds to block 1512.

At block 1512, the network interface 128 of FIG. 1 receives configuration-specific cook program data from one or more of the remote device(s) 148 of FIG. 1. For example, the network interface 128 may receive (e.g., via one or more of the communication device(s) 130 of the network interface 128) configuration-specific cook program data from one or more of the remote device(s) 148 of FIG. 1, with the received configuration-specific cook program data being specifically tailored to some or all of the grill configuration data 202 of FIG. 2 (e.g., the burner configuration data 204, the valve configuration data 206, the fuel source configuration data 208, the ignitor configuration data 210, the cooking surface configuration data 212, the table configuration data 214, the lighting module configuration data 216, the temperature sensor configuration data 218, the flame sensor configuration data 220, the lid position sensor configuration data 222, the fuel level sensor configuration data 224, the product manufacturing data 226, the product identification data 228, and/or the security data 230). Following block 1512, control of the machine-readable instructions and/or operations 1500 of FIG. 15 proceeds to block 1514.

At block 1514, the controller 132 processes the configuration-specific cook program data received from the one or more remote device(s) 148. For example, the control circuitry 134 of the controller 132 may cause some or all of the configuration-specific cook program data received from the one or more remote device(s) 148 to be stored in and/or on the main memory 140 of the grill 100 of FIG. 1, and/or to be shared with, accessed by, or otherwise made available to the user interface 122 of the grill 100 of FIG. 1. Following block 1514, control of the example machine-readable instructions and/or operations 1500 of FIG. 15 proceeds to block 1516.

At block 1516, the controller 132 implements one or more configuration-specific cook program(s) based on the configuration-specific cook program data. For example, the control circuitry 134 of the controller 132 may instruct, command, signal, and/or otherwise cause the user interface 122 and/or one or more other controllable component(s) of the grill 100 to implement (e.g., execute) one or more configuration-specific cook program(s) based on the configuration-specific cook program data, with the implemented configuration-specific cook program(s) being specifically tailored to some or all of the grill configuration data 202 of FIG. 2 (e.g., the burner configuration data 204, the valve configuration data 206, the fuel source configuration data 208, the ignitor configuration data 210, the cooking surface configuration data 212, the table configuration data 214, the lighting module configuration data 216, the temperature sensor configuration data 218, the flame sensor configuration data 220, the lid position sensor configuration data 222, the fuel level sensor configuration data 224, the product manufacturing data 226, the product identification data 228, and/or the security data 230). Following block 1516, the machine-readable instructions and/or operations 1500 of FIG. 15 end.

FIG. 16 is a block diagram of an example processor platform 1600 including processor circuitry structured to execute and/or instantiate the machine-readable instructions and/or operations of FIGS. 14 and 15 to implement the grill 100 of FIG. 1. The processor platform 1600 of the illustrated example includes processor circuitry 1602. The processor circuitry 1602 of the illustrated example is hardware. For example, the processor circuitry 1602 can be implemented by one or more integrated circuit(s), logic circuit(s), FPGA(s), microprocessor(s), CPU(s), GPU(s), DSP(s), and/or microcontroller(s) from any desired family or manufacturer. The processor circuitry 1602 may be implemented by one or more semiconductor based (e.g., silicon based) device(s). In this example, the processor circuitry 1602 implements the controller 132 of FIG. 1, including the control circuitry 134 and the detection circuitry 136 of the controller 132. In the illustrated example, the dongle 142 is in electrical communication with the processor circuitry 1602 via a connector (e.g., the connector formed by the socket 138 and the plug 146 of FIG. 1).

The processor circuitry 1602 of the illustrated example includes a local memory 1604 (e.g., a cache, registers, etc.). The processor circuitry 1602 is in electrical communication with one or more valve(s) 1606 via a bus 1608. In this example, the valve(s) 1606 include one or more of the valve(s) 104 of FIG. 1. The processor circuitry 1602 is also in electrical communication with one or more ignitor(s) 1610 via the bus 1608. In this example, the ignitor(s) 1610 include one or more of the ignitor(s) 108 of FIG. 1. The processor circuitry 1602 is also in electrical communication with one or more lighting module(s) 1612 via the bus 1608. In this example, the lighting module(s) 1612 include one or more of the lighting module(s) 112 of FIG. 1. The processor circuitry 1602 is also in electrical communication with one or more sensor(s) 1614 via the bus 1608. In this example, the sensor(s) 1614 include one or more of the temperature sensor(s) 114, one or more of the flame sensor(s) 116, one or more of the lid position sensor(s) 118, and one or more of the fuel level sensor(s) 120 of FIG. 1.

The processor circuitry 1602 is also in electrical communication with a main memory via the bus 1608, with the main memory including a volatile memory 1616 and a non-volatile memory 1618. The volatile memory 1616 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1618 may be implemented by flash memory and/or any other desired type of memory device. Access to the main memory 1616, 1618 of the illustrated example is controlled by a memory controller.

The processor platform 1600 of the illustrated example also includes one or more mass storage device(s) 1620 to store software and/or data. Examples of such mass storage device(s) 918 include magnetic storage devices, optical storage devices, floppy disk drives, HDDs, CDs, Blu-ray disk drives, redundant array of independent disks (RAID) systems, solid state storage devices such as flash memory devices, and DVD drives. In the illustrated example of FIG. 16, one or more of the volatile memory 1616, the non-volatile memory 1618, and/or the mass storage device(s) 1620 implement(s) the main memory 140 of FIG. 1.

The processor platform 1600 of the illustrated example also includes user interface circuitry 1622. The user interface circuitry 1622 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In the illustrated example, one or more input device(s) 124 are connected to the user interface circuitry 1622. The input device(s) 124 permit(s) a user to enter data and/or commands into the processor circuitry 1602. The input device(s) 124 can be implemented by, for example, one or more button(s), dial(s), knob(s), switch(es), touchscreen(s), audio sensor(s), microphone(s), image sensor(s), and/or camera(s). One or more output device(s) 126 are also connected to the user interface circuitry 1622 of the illustrated example. The output device(s) 126 can be implemented, for example, by one or more display device(s) (e.g., light emitting diode(s) (LED(s)), organic light emitting diode(s) (OLED(s)), liquid crystal display(s) (LCD(s)), cathode ray tube (CRT) display(s), in-place switching (IPS) display(s), touchscreen(s), etc.), tactile output device(s), and/or speaker(s). The user interface circuitry 1622 of the illustrated example, thus, typically includes a graphics driver card, a graphics driver chip, and/or graphics processor circuitry such as a GPU. In the illustrated example of FIG. 16, the user interface circuitry 1622, the input device(s) 124, and the output device(s) 126 collectively implement the user interface 122 of FIG. 1.

The processor platform 1600 of the illustrated example also includes network interface circuitry 1624. The network interface circuitry 1624 includes one or more communication device(s) (e.g., transmitter(s), receiver(s), transceiver(s), modem(s), gateway(s), wireless access point(s), etc.) to facilitate exchange of data with external machines (e.g., computing devices of any kind, including the remote device(s) 148 of FIG. 1) by a network 1626. The communication can be by, for example, an Ethernet connection, a digital subscriber line (DSL) connection, a telephone line connection, a coaxial cable system, a satellite system, a wireless system, a cellular telephone system, an optical connection, etc. In the illustrated example of FIG. 16, the network interface circuitry 1624 implements the network interface 128 (e.g., including the communication device(s) 130) of FIG. 1.

Coded instructions 1628 including the above-described machine-readable instructions and/or operations of FIGS. 14 and 15 may be stored in the local memory 1604, in the volatile memory 1616, in the non-volatile memory 1618, on the mass storage device(s) 1620, and/or on a removable non-transitory computer-readable storage medium such as a flash memory stick, a dongle, a CD, or a DVD.

FIG. 17 is a block diagram of an example implementation of the processor circuitry 1602 of FIG. 16. In this example, the processor circuitry 1602 of FIG. 16 is implemented by a microprocessor 1700. For example, the microprocessor 1700 may implement multi-core hardware circuitry such as a CPU, a DSP, a GPU, an XPU, etc. Although it may include any number of example cores 1702 (e.g., 1 core), the microprocessor 1700 of this example is a multi-core semiconductor device including N cores. The cores 1702 of the microprocessor 1700 may operate independently or may cooperate to execute machine-readable instructions. For example, machine code corresponding to a firmware program, an embedded software program, or a software program may be executed by one of the cores 1702 or may be executed by multiple ones of the cores 1702 at the same or different times. In some examples, the machine code corresponding to the firmware program, the embedded software program, or the software program is split into threads and executed in parallel by two or more of the cores 1702. The software program may correspond to a portion or all of the machine-readable instructions and/or operations represented by the flowcharts of FIGS. 14 and 15.

The cores 1702 may communicate by an example bus 1704. In some examples, the bus 1704 may implement a communication bus to effectuate communication associated with one(s) of the cores 1702. For example, the bus 1704 may implement at least one of an Inter-Integrated Circuit (I2C) bus, a Serial Peripheral Interface (SPI) bus, a PCI bus, or a PCIe bus. Additionally, or alternatively, the bus 1704 may implement any other type of computing or electrical bus. The cores 1702 may obtain data, instructions, and/or signals from one or more external devices by example interface circuitry 1706. The cores 1702 may output data, instructions, and/or signals to the one or more external devices by the interface circuitry 1706. Although the cores 1702 of this example include example local memory 1720 (e.g., Level 1 (L1) cache that may be split into an L1 data cache and an L1 instruction cache), the microprocessor 1700 also includes example shared memory 1710 that may be shared by the cores (e.g., Level 2 (L2_cache)) for high-speed access to data and/or instructions. Data and/or instructions may be transferred (e.g., shared) by writing to and/or reading from the shared memory 1710. The local memory 1720 of each of the cores 1702 and the shared memory 1710 may be part of a hierarchy of storage devices including multiple levels of cache memory and the main memory (e.g., the main memory 1616, 1618 of FIG. 16). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1702 may be referred to as a CPU, DSP, GPU, etc., or any other type of hardware circuitry. Each core 1702 includes control unit circuitry 1714, arithmetic and logic (AL) circuitry (sometimes referred to as an ALU) 1716, a plurality of registers 1718, the L1 cache 1720, and an example bus 1722. Other structures may be present. For example, each core 1702 may include vector unit circuitry, single instruction multiple data (SIMD) unit circuitry, load/store unit (LSU) circuitry, branch/jump unit circuitry, floating-point unit (FPU) circuitry, etc. The control unit circuitry 1714 includes semiconductor-based circuits structured to control (e.g., coordinate) data movement within the corresponding core 1702. The AL circuitry 1716 includes semiconductor-based circuits structured to perform one or more mathematic and/or logic operations on the data within the corresponding core 1702. The AL circuitry 1716 of some examples performs integer based operations. In other examples, the AL circuitry 1716 also performs floating point operations. In yet other examples, the AL circuitry 1716 may include first AL circuitry that performs integer based operations and second AL circuitry that performs floating point operations. In some examples, the AL circuitry 1716 may be referred to as an Arithmetic Logic Unit (ALU). The registers 1718 are semiconductor-based structures to store data and/or instructions such as results of one or more of the operations performed by the AL circuitry 1716 of the corresponding core 1702. For example, the registers 1718 may include vector register(s), SIMD register(s), general purpose register(s), flag register(s), segment register(s), machine specific register(s), instruction pointer register(s), control register(s), debug register(s), memory management register(s), machine check register(s), etc. The registers 1718 may be arranged in a bank as shown in FIG. 17. Alternatively, the registers 1718 may be organized in any other arrangement, format, or structure including distributed throughout the core 1702 to shorten access time. The bus 1722 may implement at least one of an I2C bus, a SPI bus, a PCI bus, or a PCIe bus.

Each core 1702 and/or, more generally, the microprocessor 1700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)), and/or other circuitry may be present. The microprocessor 1700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

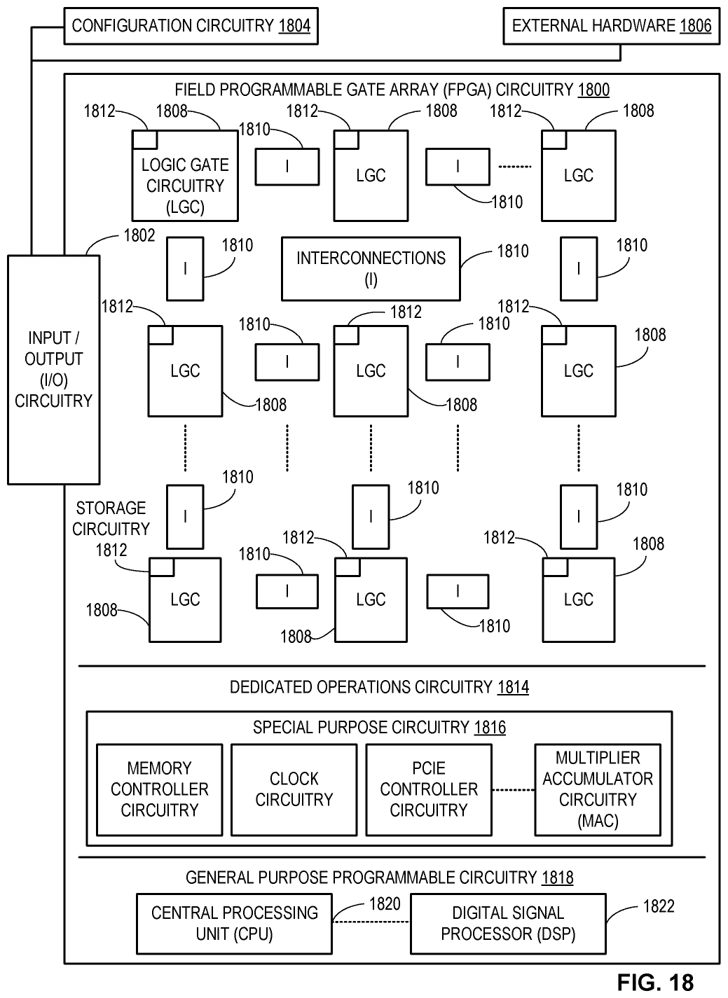

FIG. 18 is a block diagram of another example implementation of the processor circuitry 1602 of FIG. 16. In this example, the processor circuitry 1602 is implemented by FPGA circuitry 1800. The FPGA circuitry 1800 can be used, for example, to perform operations that could otherwise be performed by the example microprocessor 1700 of FIG. 17 executing corresponding machine-readable instructions. However, once configured, the FPGA circuitry 1800 instantiates the machine-readable instructions in hardware and, thus, can often execute the operations faster than they could be performed by a general purpose microprocessor executing the corresponding software.

More specifically, in contrast to the microprocessor 1700 of FIG. 17 described above (which is a general purpose device that may be programmed to execute some or all of the machine-readable instructions and/or operations represented by the flowcharts of FIGS. 14 and 15, but whose interconnections and logic circuitry are fixed once fabricated), the FPGA circuitry 1800 of the example of FIG. 18 includes interconnections and logic circuitry that may be configured and/or interconnected in different ways after fabrication to instantiate, for example, some or all of the machine-readable instructions and/or operations represented by the flowcharts of FIGS. 14 and 15. In particular, the FPGA circuitry 1800 may be thought of as an array of logic gates, interconnections, and switches. The switches can be programmed to change how the logic gates are interconnected by the interconnections, effectively forming one or more dedicated logic circuits (unless and until the FPGA circuitry 1800 is reprogrammed). The configured logic circuits enable the logic gates to cooperate in different ways to perform different operations on data received by input circuitry. Those operations may correspond to some or all of the software represented by the flowcharts of FIGS. 14 and 15. As such, the FPGA circuitry 1800 may be structured to effectively instantiate some or all of the machine-readable instructions of the flowcharts of FIGS. 14 and 15 as dedicated logic circuits to perform the operations corresponding to those software instructions in a dedicated manner analogous to an ASIC. Therefore, the FPGA circuitry 1800 may perform the operations corresponding to the some or all of the machine-readable instructions of FIGS. 14 and 15 faster than the general purpose microprocessor can execute the same.

In the example of FIG. 18, the FPGA circuitry 1800 is structured to be programmed (and/or reprogrammed one or more times) by an end user by a hardware description language (HDL) such as Verilog. The FPGA circuitry 1800 of FIG. 18 includes example input/output (I/O) circuitry 1802 to obtain and/or output data to/from example configuration circuitry 1804 and/or external hardware (e.g., external hardware circuitry) 1806. For example, the configuration circuitry 1804 may implement interface circuitry that may obtain machine-readable instructions to configure the FPGA circuitry 1800, or portion(s) thereof. In some such examples, the configuration circuitry 1804 may obtain the machine-readable instructions from a user, a machine (e.g., hardware circuitry (e.g., programmed, or dedicated circuitry) that may implement an Artificial Intelligence/Machine Learning (AI/ML) model to generate the instructions), etc. In some examples, the external hardware 1806 may implement the microprocessor 1700 of FIG. 17. The FPGA circuitry 1800 also includes an array of example logic gate circuitry 1808, a plurality of example configurable interconnections 1810, and example storage circuitry 1812. The logic gate circuitry 1808 and interconnections 1810 are configurable to instantiate one or more operations that may correspond to at least some of the machine-readable instructions of FIGS. 14 and 15 and/or other desired operations. The logic gate circuitry 1808 shown in FIG. 18 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 1808 to enable configuration of the electrical structures and/or the logic gates to form circuits to perform desired operations. The logic gate circuitry 1808 may include other electrical structures such as look-up tables (LUTs), registers (e.g., flip-flops or latches), multiplexers, etc.

The interconnections 1810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1808 to program desired logic circuits.

The storage circuitry 1812 of the illustrated example is structured to store result(s) of the one or more of the operations performed by corresponding logic gates. The storage circuitry 1812 may be implemented by registers or the like. In the illustrated example, the storage circuitry 1812 is distributed amongst the logic gate circuitry 1808 to facilitate access and increase execution speed.

The example FPGA circuitry 1800 of FIG. 18 also includes example Dedicated Operations Circuitry 1814. In this example, the Dedicated Operations Circuitry 1814 includes special purpose circuitry 1816 that may be invoked to implement commonly used functions to avoid the need to program those functions in the field. Examples of such special purpose circuitry 1816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1800 may also include example general purpose programmable circuitry 1818 such as an example CPU 1820 and/or an example DSP 1822. Other general purpose programmable circuitry 1818 may additionally or alternatively be present such as a GPU, an XPU, etc., that can be programmed to perform other operations.

Although FIGS. 17 and 18 illustrate two example implementations of the processor circuitry 1602 of FIG. 16, many other approaches are contemplated. For example, as mentioned above, modern FPGA circuitry may include an on-board CPU, such as one or more of the example CPU 1820 of FIG. 18. Therefore, the processor circuitry 1602 of FIG. 16 may additionally be implemented by combining the example microprocessor 1000 of FIG. 10 and the example FPGA circuitry 1800 of FIG. 18. In some such hybrid examples, a first portion of the machine-readable instructions and/or operations represented by the flowcharts of FIGS. 14 and 15 may be executed by one or more of the cores 1702 of FIG. 17 and a second portion of the machine-readable instructions and/or operations represented by the flowcharts of FIGS. 14 and 15 may be executed by the FPGA circuitry 1800 of FIG. 18.

In some examples, the processor circuitry 1602 of FIG. 16 may be in one or more packages. For example, the microprocessor 1700 of FIG. 17 and/or the FPGA circuitry 1800 of FIG. 18 may be in one or more packages. In some examples, an XPU may be implemented by the processor circuitry 1602 of FIG. 16, which may be in one or more packages. For example, the XPU may include a CPU in one package, a DSP in another package, a GPU in yet another package, and an FPGA in still yet another package.

From the foregoing, it will be appreciated that the above-disclosed methods and apparatus advantageously supply configuration data to controllers of grills. In some examples, grills disclosed herein include a controller and a dongle that is connectable to the controller. The dongle includes memory storing (e.g., preloaded with) configuration data associated with the grill. The controller is configured to read the configuration data from the memory of the dongle in response to the dongle being connected to the controller. In some examples, the controller may detect the connection between the dongle and the controller during a boot up cycle of the controller and/or, more generally, of the grill. The data read by the controller from the memory of the dongle can thereafter be stored in and/or on a main memory of the grill, and/or accessed via a user interface of the grill.

In some examples, the grill transmits the configuration data read from the memory of the dongle to one or more remote device(s) to advantageously facilitate a registration process associated with the grill. In such examples, the configuration data may include product manufacturing data and/or product identification data that may be required to complete the registration process. In such examples, the transmission of the configuration data from the grill to the remote device(s) advantageously reduces (e.g., eliminates) one or more act(s) of user involvement that is/are required in association with known grill registration processes, thereby providing a user experience that is improved relative to that provided by such known grill registration processes.

In some examples, the grill transmits the configuration data read from the memory of the dongle to one or more remote device(s) to advantageously facilitate the identification of one or more configuration-specific cook program(s). In such examples, the configuration data may include burner configuration data, valve configuration data, fuel source configuration data, ignitor configuration data, cooking surface configuration data, table configuration data, lighting module configuration data, temperature sensor configuration data, flame sensor configuration data, lid position sensor configuration data, fuel level sensor configuration data, and/or other types or categories of configuration data associated with the grill. In response to transmitting the configuration data from the grill to the remote device(s), the grill may thereafter receive configuration-specific cook program data from the remote device(s), with the configuration-specific cook program data being based on the configuration data. The controller and/or the user interface of the grill can thereafter implement one or more configuration-specific cook program(s) that is/are based on the received configuration-specific cook program data. In such examples, the implementation of the configuration-specific cook program(s) advantageously optimizes the use of cook programs at the grill, thereby providing a user experience that is improved relative to that provided by known cook program implementations.

In some examples, a grill is disclosed. In some disclosed examples, the grill comprises a controller and a dongle. In some disclosed examples, the dongle is connectable to the controller. In some disclosed examples, the dongle includes memory storing configuration data associated with the grill. In some disclosed examples, the controller is to read the configuration data from the memory in response to the dongle being connected to the controller.

In some disclosed examples, the grill further comprises a main memory in electrical communication with the controller. In some disclosed examples, the main memory is to store the configuration data read from the memory of the dongle.

In some disclosed examples, the grill further comprises a user interface in electrical connection with the controller. In some disclosed examples, the user interface is to access the configuration data read from the memory of the dongle.

In some disclosed examples, the grill is to transmit the configuration data read from the memory of the dongle to a remote device.

In some disclosed examples, the grill is to transmit the configuration data read from the memory of the dongle to a remote device to facilitate a registration process associated with the grill.

In some disclosed examples, the configuration data includes product identification data. In some disclosed examples, the product identification data includes a serial number of the grill.

In some disclosed examples, the grill is to transmit the configuration data read from the memory of the dongle to a remote device to facilitate identification of one or more configuration-specific cook programs.

In some disclosed examples, the grill is to receive configuration-specific cook program data from the remote device. In some disclosed examples, the configuration-specific cook program data is based on the configuration data.

In some disclosed examples, the controller is to implement a configuration-specific cook program based on the received configuration-specific cook program data.

In some disclosed examples, the controller is to read the configuration data from the memory of the dongle to facilitate completion of an authentication process associated with the grill.

In some disclosed examples, the configuration data includes security data. In some disclosed examples, the security data includes at least a portion of a security key, an encryption key, or an access key that is needed to unlock a feature of the grill.

In some disclosed examples, the dongle includes a plug, the controller includes a socket, and the plug is connectable to the socket.

In some disclosed examples, the dongle includes a housing having a first portion and a second portion. In some disclosed examples, the second portion is removably couplable to the first portion. In some disclosed examples, the memory of the dongle is located within the housing.

In some disclosed examples, the dongle includes a mounting flange extending from the second portion of the housing. In some disclosed examples, the mounting flange includes an opening configured to receive a fastener to facilitate coupling the dongle to a structure of the grill.

In some disclosed examples, the grill further comprises a side table. In some disclosed examples, the controller and the dongle are respectively coupled to the side table.

In some disclosed examples, the configuration data includes at least one of burner configuration data associated with the grill, valve configuration data associated with the grill, fuel source configuration data associated with the grill, ignitor configuration data associated with the grill, cooking surface configuration data associated with the grill, table configuration data associated with the grill, lighting module configuration data associated with the grill, temperature sensor configuration data associated with the grill, flame sensor configuration data associated with the grill, lid position sensor configuration data associated with the grill, fuel level sensor configuration data associated with the grill, product manufacturing data associated with the grill, or product identification data associated with the grill.

In some examples, a method is disclosed. In some disclosed examples, the method comprises determining, via a controller of a grill, whether a dongle of the grill is connected to the controller. In some disclosed examples, the dongle includes memory storing configuration data associated with the grill. In some disclosed examples, the method further comprises reading, via the controller, the configuration data from the memory in response to determining that the dongle is connected to the controller.

In some disclosed examples, the method further comprises storing the configuration data read from the memory of the dongle on a main memory of the grill. In some disclosed examples, the main memory is in electrical communication with the controller.

In some disclosed examples, the method further comprises providing a user interface of the grill with access to the configuration data read from the memory of the dongle. In some disclosed examples, the user interface is in electrical communication with the controller.

In some disclosed examples, the method further comprises transmitting the configuration data read from the memory of the dongle to a remote device.

In some disclosed examples, the method further comprises transmitting the configuration data read from the memory of the dongle to a remote device to facilitate a registration process associated with the grill.

In some disclosed examples, the configuration data includes product identification data. In some disclosed examples, the product identification data includes a serial number of the grill.

In some disclosed examples, the method further comprises transmitting the configuration data read from the memory of the dongle to a remote device to facilitate identification of one or more configuration-specific cook programs.

In some disclosed examples, the method further comprises receiving configuration-specific cook program data at the grill from the remote device. In some disclosed examples, the configuration-specific cook program data is based on the configuration data.

In some disclosed examples, the method further comprises implementing, via the controller, a configuration-specific cook program at the grill based on the received configuration-specific cook program data.

In some disclosed examples, reading the configuration data from the memory of the dongle facilitates completion of an authentication process associated with the grill.

In some disclosed examples, the configuration data includes security data. In some disclosed examples, the security data includes at least a portion of a security key, an encryption key, or an access key that is needed to unlock a feature of the grill.

In some examples, a non-transitory computer-readable medium comprising computer-readable instructions is disclosed. In some disclosed examples, the computer-readable instructions, when executed cause one or more processors of a grill to determine whether a dongle of the grill is connected to a controller of the grill. In some disclosed examples, the dongle includes memory storing configuration data associated with the grill. In some disclosed examples, the computer-readable instructions, when executed further cause the one or more processors to read the configuration data from the memory in response to determining that the dongle is connected to the controller.

In some disclosed examples, the computer-readable instructions, when executed further cause the one or more processors to store the configuration data read from the memory of the dongle on a main memory of the grill. In some disclosed examples, the main memory is in electrical communication with the controller.

In some disclosed examples, the computer-readable instructions, when executed further cause the one or more processors to provide a user interface of the grill with access to the configuration data read from the memory of the dongle. In some disclosed examples, the user interface is in electrical communication with the controller.

In some disclosed examples, the computer-readable instructions, when executed further cause the one or more processors to transmit the configuration data read from the memory of the dongle to a remote device.

In some disclosed examples, the computer-readable instructions, when executed further cause the one or more processors to transmit the configuration data read from the memory of the dongle to a remote device to facilitate a registration process associated with the grill.

In some disclosed examples, the configuration data includes product identification data. In some disclosed examples, the product identification data includes a serial number of the grill.

In some disclosed examples, the computer-readable instructions, when executed further cause the one or more processors to transmit the configuration data read from the memory of the dongle to a remote device to facilitate identification of one or more configuration-specific cook programs.

In some disclosed examples, the computer-readable instructions, when executed further cause the one or more processors to access configuration-specific cook program data received at the grill from the remote device. In some disclosed examples, the configuration-specific cook program data is based on the configuration data.

In some disclosed examples, the computer-readable instructions, when executed further cause the one or more processors to implement a configuration-specific cook program at the grill based on the received configuration-specific cook program data.

In some disclosed examples, the reading of the configuration data from the memory of the dongle facilitates completion of an authentication process associated with the grill.

In some disclosed examples, the configuration data includes security data. In some disclosed examples, the security data includes at least a portion of a security key, an encryption key, or an access key that is needed to unlock a feature of the grill.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. A grill, comprising:
a controller; and
a dongle connectable to the controller, the dongle including memory, the memory storing configuration data associated with the grill, the controller to read the configuration data from the memory in response to the dongle being connected to the controller.

2. The grill of claim 1, further comprising a main memory in electrical communication with the controller, wherein the main memory is to store the configuration data read from the memory of the dongle.

3. The grill of claim 1, further comprising a user interface in electrical connection with the controller, wherein the user interface is to access the configuration data read from the memory of the dongle.

4. The grill of claim 1, wherein the grill is to transmit the configuration data read from the memory of the dongle to a remote device.

5. The grill of claim 1, wherein the grill is to transmit the configuration data read from the memory of the dongle to a remote device to facilitate a registration process associated with the grill.

6. The grill of claim 5, wherein the configuration data includes product identification data.

7. The grill of claim 6, wherein the product identification data includes a serial number of the grill.

8. The grill of claim 1, wherein the grill is to transmit the configuration data read from the memory of the dongle to a remote device to facilitate identification of one or more configuration-specific cook programs.

9. The grill of claim 8, wherein the grill is to receive configuration-specific cook program data from the remote device, the configuration-specific cook program data being based on the configuration data.

10. The grill of claim 9, wherein the controller is to implement a configuration-specific cook program based on the received configuration-specific cook program data.

11. The grill of claim 1, wherein the controller is to read the configuration data from the memory of the dongle to facilitate completion of an authentication process associated with the grill.

12. The grill of claim 11, wherein the configuration data includes security data.

13. The grill of claim 12, wherein the security data includes at least a portion of a security key, an encryption key, or an access key that is needed to unlock a feature of the grill.

14. The grill of claim 1, wherein the dongle includes a plug, the controller includes a socket, and the plug is connectable to the socket.

15. The grill of claim 1, wherein the dongle includes a housing having a first portion and a second portion, the second portion removably couplable to the first portion, the memory of the dongle located within the housing.

16. The grill of claim 15, wherein the dongle includes a mounting flange extending from the second portion of the housing, the mounting flange including an opening configured to receive a fastener to facilitate coupling the dongle to a structure of the grill.

17. The grill of claim 1, further comprising a side table, wherein the controller and the dongle are respectively coupled to the side table.

18. The grill of claim 1, wherein the configuration data includes at least one of burner configuration data associated with the grill, valve configuration data associated with the grill, fuel source configuration data associated with the grill, ignitor configuration data associated with the grill, cooking surface configuration data associated with the grill, table configuration data associated with the grill, lighting module configuration data associated with the grill, temperature sensor configuration data associated with the grill, flame sensor configuration data associated with the grill, lid position sensor configuration data associated with the grill, fuel level sensor configuration data associated with the grill, product manufacturing data associated with the grill, or product identification data associated with the grill.

19. A method, comprising:
determining, via a controller of a grill, whether a dongle of the grill is connected to the controller, the dongle including memory, the memory storing configuration data associated with the grill; and
reading, via the controller, the configuration data from the memory in response to determining that the dongle is connected to the controller.

20-31. (canceled)

32. A non-transitory computer-readable medium comprising computer-readable instructions that, when executed, cause one or more processors of a grill to at least:
determine whether a dongle of the grill is connected to a controller of the grill, the dongle including memory, the memory storing configuration data associated with the grill; and
read the configuration data from the memory in response to determining that the dongle is connected to the controller.

33-44. (canceled)
